(19) United States
(12) Patent Application Publication
(10) Pub. No.: US 2018/0336654 A1
(43) Pub. Date: Nov. 22, 2018

(54) MASS-PRODUCIBLE BESPOKE BUILDING COMPONENT SYSTEM AND METHOD

(71) Applicant: 9469044 CANADA INC., Gatineau (CA)

(72) Inventor: Geneviève Girard, Gatineau (Quebec) (CA)

(73) Assignee: 9469044 CANADA INC., Gatineau (CA)

(21) Appl. No.: 15/983,173

(22) Filed: May 18, 2018

Related U.S. Application Data
(60) Provisional application No. 62/509,018, filed on May 19, 2017.

(51) Int. Cl. G06Q 99/00

(52) U.S. Cl. CPC G06Q 99/00

(57) ABSTRACT

Disclosed herein is a method of mass-producing components of bespoke buildings. The method includes the steps of: (a) manufacturing mass-producible components; (b) boxing the mass-producible components; (c) stocking boxes of the mass-producible components; (d) selecting at least one box of the mass-producible components; (e) providing the selected at least one box of the mass-producible components; (f) unboxing the provided at least one box of the mass-producible components; (g) building at least a portion of a bespoke building using the provided unboxed at least one mass-producible components. Bespoke buildings including mass-produced components using the method are also disclosed.

### CROSS-REFERENCE TO RELATED APPLICATIONS

The present application is related to application U.S. provisional patent application Ser. No. 62/509,018, filed May 19, 2017, for MASS-PRODUCIBLE BESPOKE BUILDING COMPONENT SYSTEM AND METHOD, by Geneviève Girard, included by reference herein and for which benefit of the priority date is hereby claimed.

### MICROFICHE APPENDIX

Not applicable.

### TECHNICAL FIELD

This application relates to buildings in general, and to a mass-producible bespoke building component system and method, in particular.

### BACKGROUND

There is a trend in the building market towards bespoke houses, particularly prefabricated houses. Typically the home owner works with a builder that takes on responsibility for designing, building, and delivering a complete bespoke building to the owner. A further trend in this direction is that of the so called tiny house, typically built on a trailer base, so that delivery consists of pulling the tiny house on its trailer to its destination.

An inconvenience in bespoke buildings is that the homes themselves need to be individually built to order, and therefore cannot easily be mass-produced so as to meet consumer demand.

### SUMMARY

According to one aspect of the present disclosure, there is provided a method of mass-producing components of bespoke buildings. The method includes the steps of: (a) manufacturing mass-producible components; (b) boxing the mass-producible components; (c) stocking boxes of the mass-producible components; (d) selecting at least one box of the mass-producible components; (e) providing the selected at least one box of the mass-producible components; (f) unboxing the provided at least one box of the mass-producible components; (g) building at least a portion of a bespoke building using the provided unboxed at least one mass-producible components. In some embodiments, the mass-producible components of step (a) include at least one of a window component, a door component, a wall component, a junction component, a column component, a beam component, a floor component, a ceiling component, a roof component, a staircase component, a solar panel component, a patio component, and a compressor component. In some embodiments, the window component is one of a 4 foot by 4 foot window component, a 3 foot by 7 foot window component, and a 8 foot by 7 foot window component. In some embodiments, the window component is one of a fixed window component and an opening window component. In some embodiments, the door component is one of an 8 foot by 7 foot door component, and a 3 foot by 7 foot door component. In some embodiments, the door component is one of a patio door component and a glass door component. In some embodiments, the wall component is a 5 foot by 10 foot wall component. In some embodiments, a component is insulated. In some embodiments, the wall component includes a recess. In some embodiments, the recess in the wall component is one of a 4 foot by 7 foot recess on a lower corner, a 3 foot by 7 foot recess on a lower corner of the wall component, a 4 foot by 4 foot recess centred on a side of the wall component, and a 3 foot by 7 foot recess on a bottom of the wall component. In some embodiments, the junction component is one of a corner junction component and a simple junction component. In some embodiments, the column component is an exterior column component. In some embodiments, one of the junction component, the column component, and the beam component is 1 foot by 10 foot. In some embodiments, one of the ceiling component and the floor component is one of 6 foot by 6 foot, 5 foot by 100 foot, 6 foot by 10 foot, and 5 foot by 12 foot. In some embodiments, the ceiling component and the floor component are provided by the same component. In some embodiments, the patio component is one of a modulable sun shade, a modulable guard rail, a modulable staircase, a solar panel. In some embodiments, the portion of the bespoke building includes a bespoke assembly. In some embodiments, the bespoke assembly is one of a greenhouse assembly, a cantilevered terrace assembly, a parapet assembly, a roof assembly, a ceiling assembly, a floor assembly, a wall assembly, a floor and wall assembly, and a patio assembly. In some embodiments, further comprising the step of building at least two bespoke assemblies using the unboxed provided mass-producible components; and combining the at least two bespoke assemblies to provide a bespoke building.

According to another aspect of the present disclosure, there is provided a mass-producible bespoke building including: (a) a mass-producible bespoke floor assembly including a plurality of mass-producible floor components; (b) a mass-producible bespoke wall assembly including a plurality of components including at least one mass-producible wall component, at least one mass-producible window component, and at least one mass-producible door component; (c) a mass-producible bespoke ceiling assembly including a plurality of mass-producible ceiling components; and (d) a mass-producible bespoke roof assembly including a plurality of mass-producible roof components; wherein each of the components is produced by the provided method. In some embodiments, the mass producible bespoke building further includes a mass-producible bespoke patio assembly including a plurality of mass-producible patio components.

Other aspects and features of the present techniques will become apparent to those ordinarily skilled in the art upon review of the following description of specific embodiments of a mass-producible bespoke building component system and method in conjunction with the accompanying drawing figures.

### BRIEF DESCRIPTION OF THE DRAWINGS

Embodiments of the present application will now be described, by way of example only, with reference to the accompanying drawing figures, wherein:

FIG. 1 is a flow chart illustrating a method of mass-producing components of bespoke buildings;

FIG. 2 illustrates a warehouse stocked with boxes containing mass-produced components for bespoke buildings; and

FIG. 3 illustrates a first exemplary set of mass-producible components and an example assembly of components into a bespoke building assembly;

FIG. 4 illustrates a second exemplary set of mass-producible components and an example assembly of components into a bespoke building assembly;

FIG. 5 illustrates in greater detail one of the exemplary mass-producible components of FIG. 3;

FIG. 6 illustrates in greater detail one of the exemplary mass-producible components of FIG. 3;

FIG. 7 illustrates in greater detail one of the exemplary mass-producible components of FIG. 3;

FIG. 8 illustrates in greater detail one of the exemplary mass-producible components of FIG. 3;

FIG. 9 illustrates in greater detail one of the exemplary mass-producible components of FIG. 3;

FIG. 10 illustrates in greater detail one of the exemplary mass-producible components of FIG. 3;

FIG. 11 illustrates in greater detail one of the exemplary mass-producible components of FIG. 3;

FIG. 12 illustrates in greater detail one of the exemplary mass-producible components of FIG. 3;

FIG. 13 illustrates in greater detail one of the exemplary mass-producible components of FIG. 3;

FIG. 14 illustrates in greater detail one of the exemplary mass-producible components of FIG. 3;

FIG. 15 illustrates in greater detail one of the exemplary mass-producible components of FIG. 3;

FIG. 16 illustrates in greater detail one of the exemplary mass-producible components of FIG. 3;

FIG. 17 illustrates in greater detail one of the exemplary mass-producible components of FIG. 3;

FIG. 18 illustrates in greater detail one of the exemplary mass-producible components of FIG. 3;

FIG. 19 illustrates in greater detail one of the-exemplary mass-producible components of FIG. 4;

FIG. 20 illustrates in greater detail one of the-exemplary mass-producible components of FIG. 4;

FIG. 21 illustrates in greater detail one of the-exemplary mass-producible components of FIG. 4;

FIG. 22 illustrates in greater detail one of the-exemplary mass-producible components of FIG. 4;

FIG. 23 illustrates in greater detail one of the-exemplary mass-producible components of FIG. 4;

FIG. 24 illustrates in greater detail one of the-exemplary mass-producible components of FIG. 4;

FIG. 25 illustrates in greater detail one of the-exemplary mass-producible components of FIG. 4;

FIG. 26 illustrates in greater detail one of the-exemplary mass-producible components of FIG. 4;

FIG. 27 illustrates in greater detail one of the-exemplary mass-producible components of FIG. 4;

FIG. 28 illustrates in greater detail one of the-exemplary mass-producible components of FIG. 4;

FIG. 29 illustrates in greater detail one of the-exemplary mass-producible components of FIG. 4;

FIG. 30 illustrates in greater detail one of the-exemplary mass-producible components of FIG. 4;

FIG. 31 illustrates in greater detail one of the-exemplary mass-producible components of FIG. 4;

FIG. 32 illustrates in greater detail one of the-exemplary mass-producible components of FIG. 4;

FIG. 33 illustrates in greater detail one of the-exemplary mass-producible components of FIG. 4;

FIG. 34 illustrates in greater detail one of the-exemplary mass-producible components of FIG. 4;

FIG. 35 illustrates how several mass-producible components can be combined to a bespoke assembly;

FIG. 36 illustrates how several mass-producible components can be combined to a bespoke assembly;

FIG. 37 illustrates how several mass-producible components can be combined to a bespoke assembly;

FIG. 38 illustrates how several mass-producible components can be combined to a bespoke assembly;

FIG. 39 illustrates how several mass-producible components can be combined to a bespoke assembly;

FIG. 40 illustrates how several mass-producible components can be combined to a bespoke assembly;

FIG. 41 illustrates a first exemplary mass-producible bespoke home built using mass-producible components;

FIG. 42 illustrates another exemplary mass-producible bespoke home built using mass-producible components;

FIG. 43 illustrates an example mass-producible flood proofing component; and

FIG. 44 illustrates another example mass-producible flood proofing component.

Like reference numerals are used in different figures to denote similar elements.

### DETAILED DESCRIPTION OF THE DRAWINGS

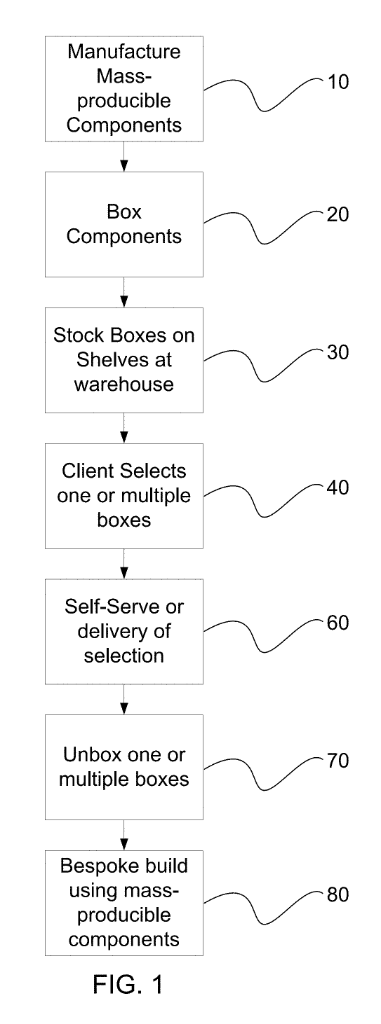

Referring to the drawings, FIG. 1 is a flow chart illustrating a method of mass-producing components of bespoke buildings. At a first step 10 “Manufacture mass-producible Components”, components are manufactured and can be mass-produced, into for example panels. Next, at step 20 “Box Components”, the components are boxed, at step 30 “Stock Boxes on Shelves at warehouse”, components are stocked in their boxes on shelves at a warehouse. At step 40 “Client Selects one or multiple boxes”, a client selects one or multiple boxes, at step 60 “Self-serve or delivery selection”, the client serves themselves or has their selection of components delivered, at step 70 “Unbox one or multiple boxes”, the client unboxes one or multiple boxes containing their components, and at step 80 “Bespoke build using mass-producible components”, the client builds their bespoke building using the mass-producible components.

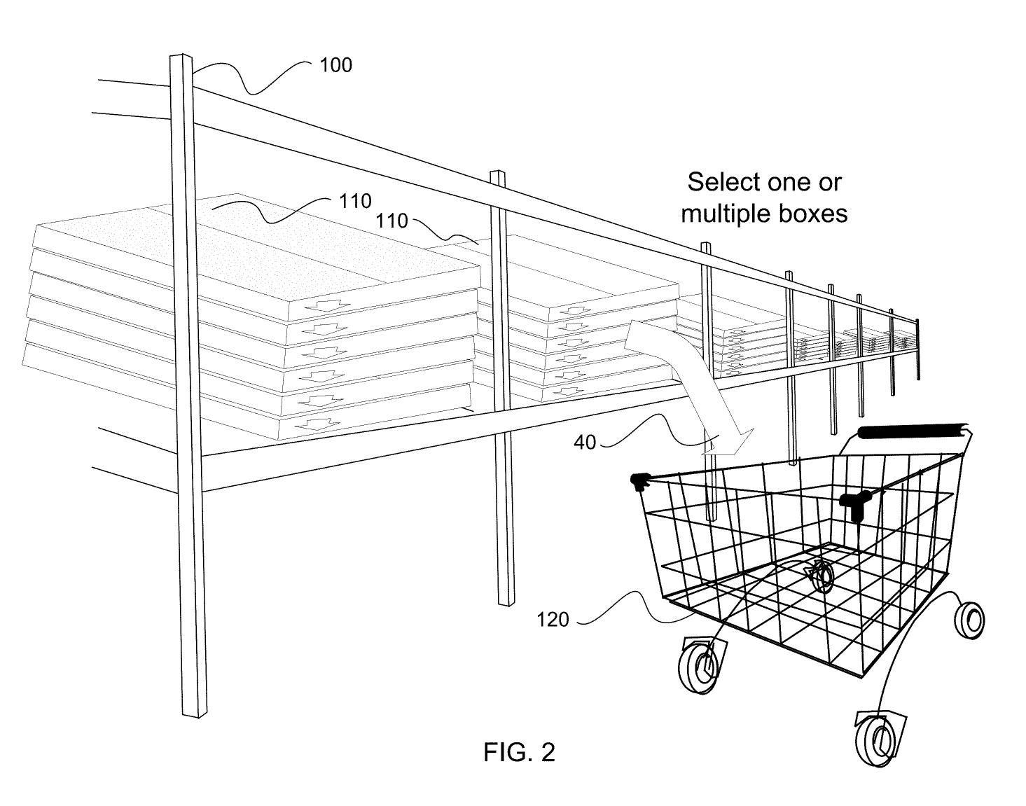

FIG. 2 illustrates a warehouse stocked with boxes containing mass-produced components for bespoke buildings. A consumer selects one or multiple boxes 110 containing mass-producible components for building, maintaining, or upgrading their bespoke building such as a bespoke home. Although a warehouse shelving system 100 and a shopping cart 120 is illustrated, it is contemplated by the inventor to offer an on-line store allowing for on-line purchase of the mass-producible components for taking either business to consumer sales or business to business sales. It is contemplated that plans for bespoke homes can be easily documented because the mass-producible components they utilize are compatible with one another. It is further contemplated that the bespoke plans could be shared, bought, or sold using an on-line repository. Further still, in a business to business on-line store, it is contemplated that a white label platform could be used to enable a reseller to brand their bespoke buildings, such as for example to offer the design, delivery, building, maintenance, and upgrade service of mass-producible bespoke homes.

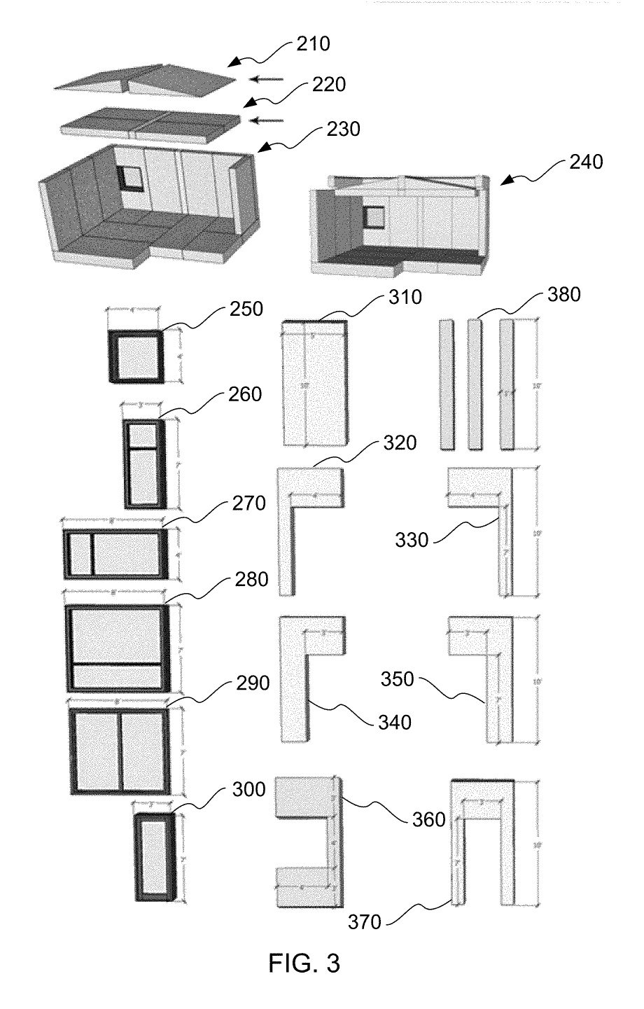

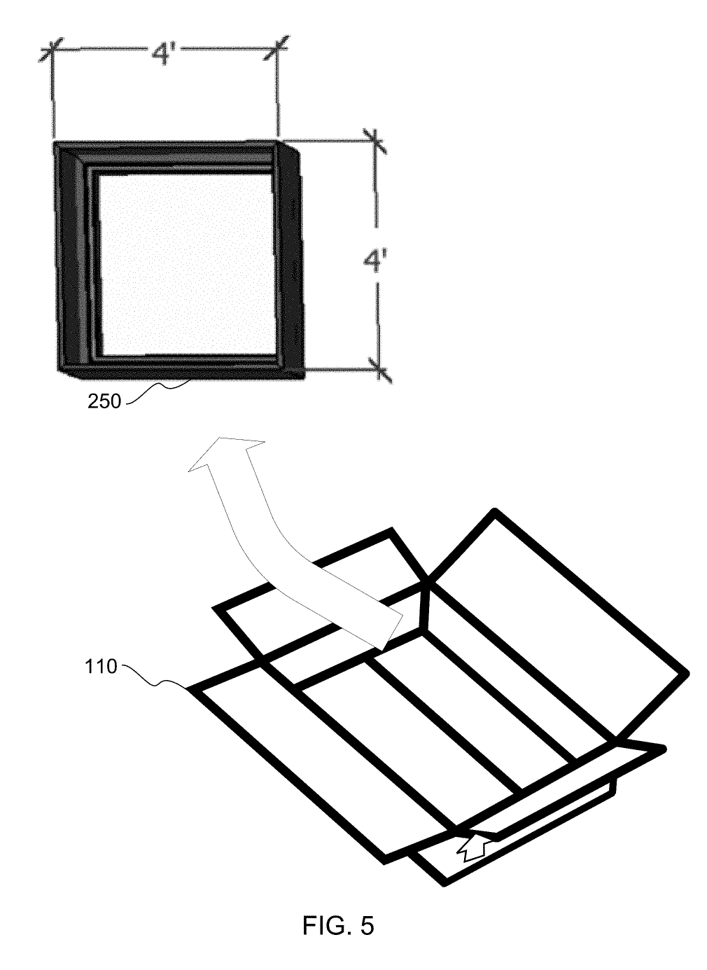

FIG. 3 illustrates a first exemplary set of mass-producible components and an example assembly of those components into a bespoke building assembly. The example bespoke building assemblies 210, 220, 230, 240 could be part of a plan that the consumer is designing using the mass-producible components. Thus, this illustration is both an example of a catalog of mass-producible parts that could be printed, or provided as part of the on-line service offering described in relation to FIG. 2. Each of the mass-producible components 250, 260, 270, 280, 290, 300, 310, 320, 330, 340, 350, 360, 370, 280 illustrated in FIG. 3 is reproduced in greater detail in FIGS. 5-17.

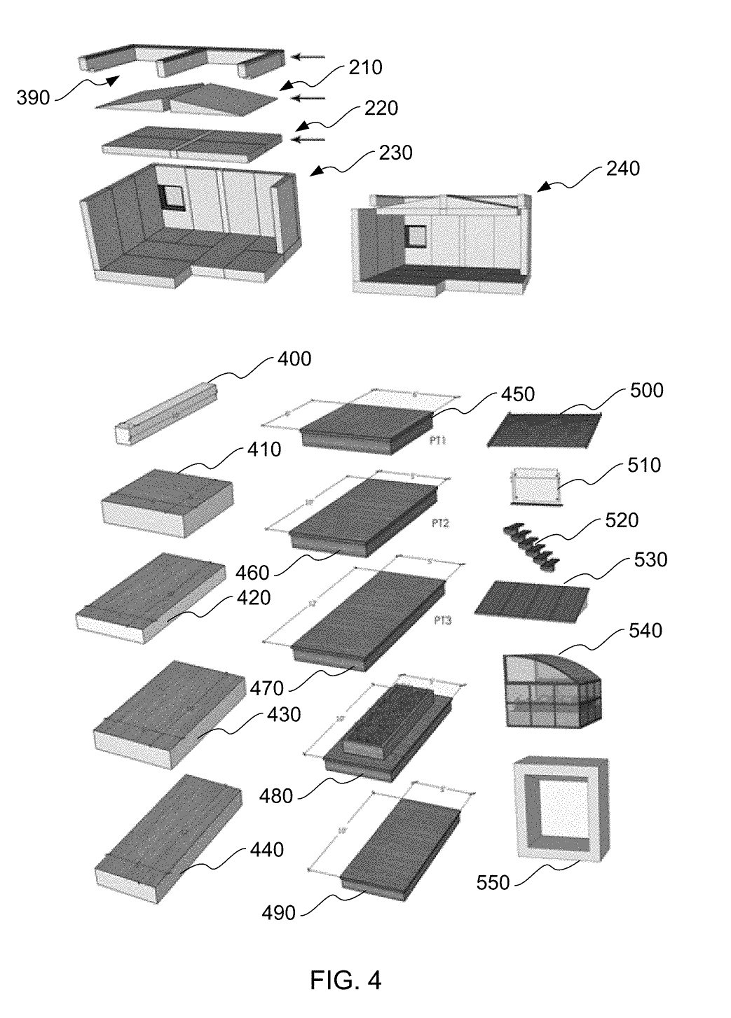

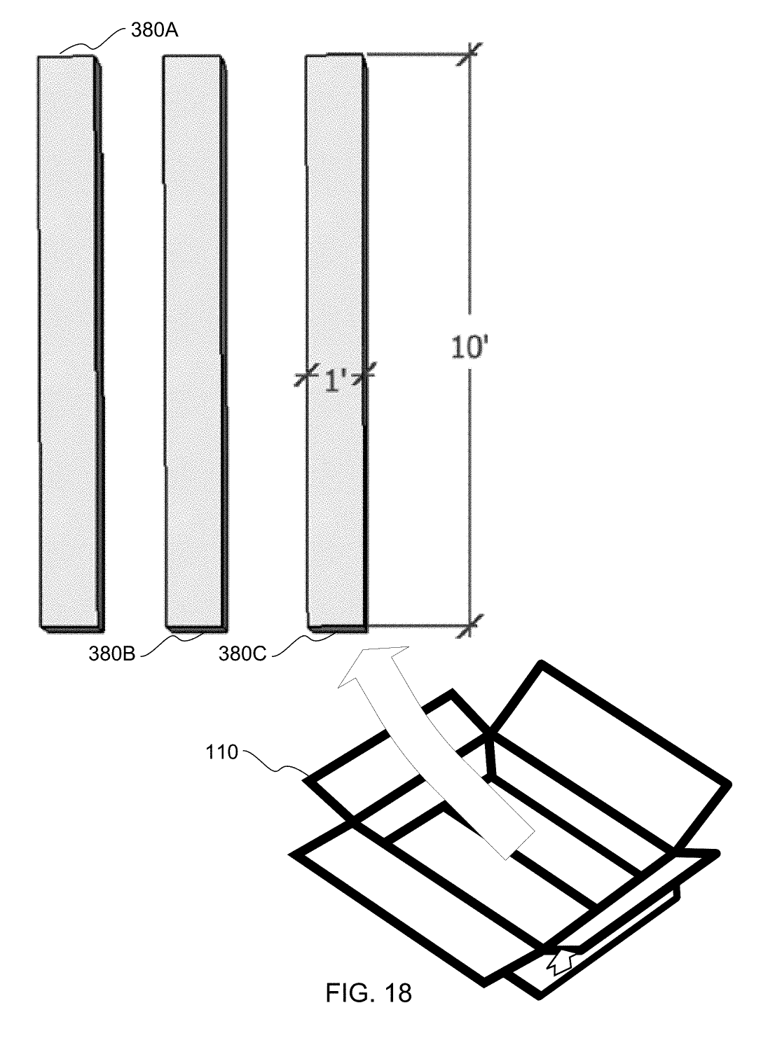

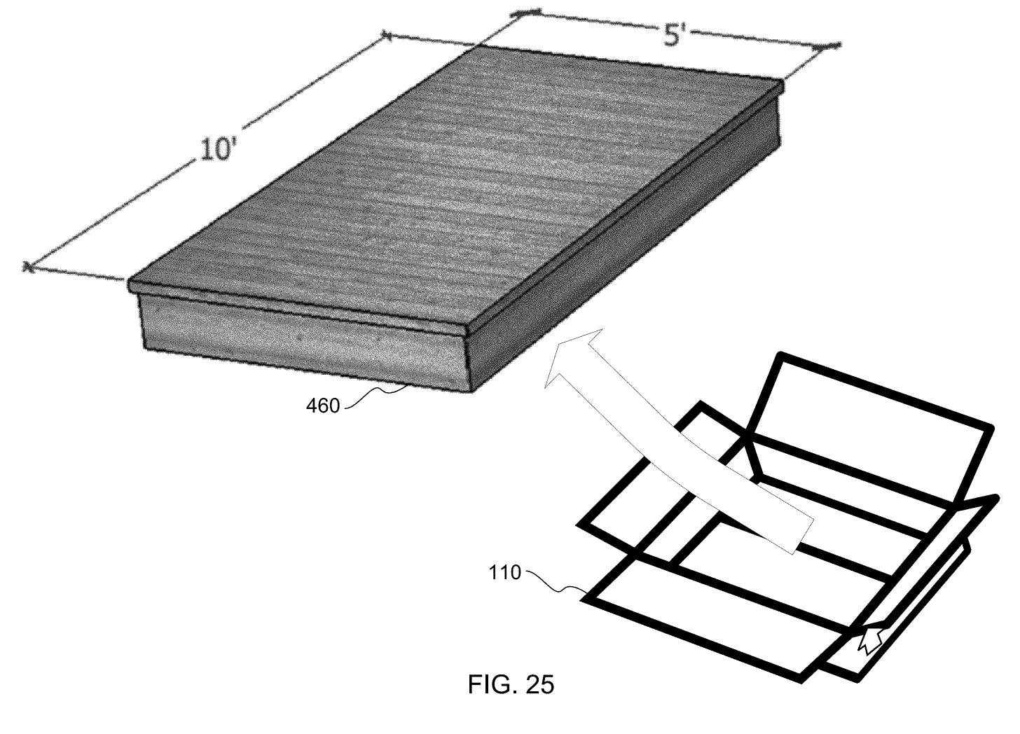

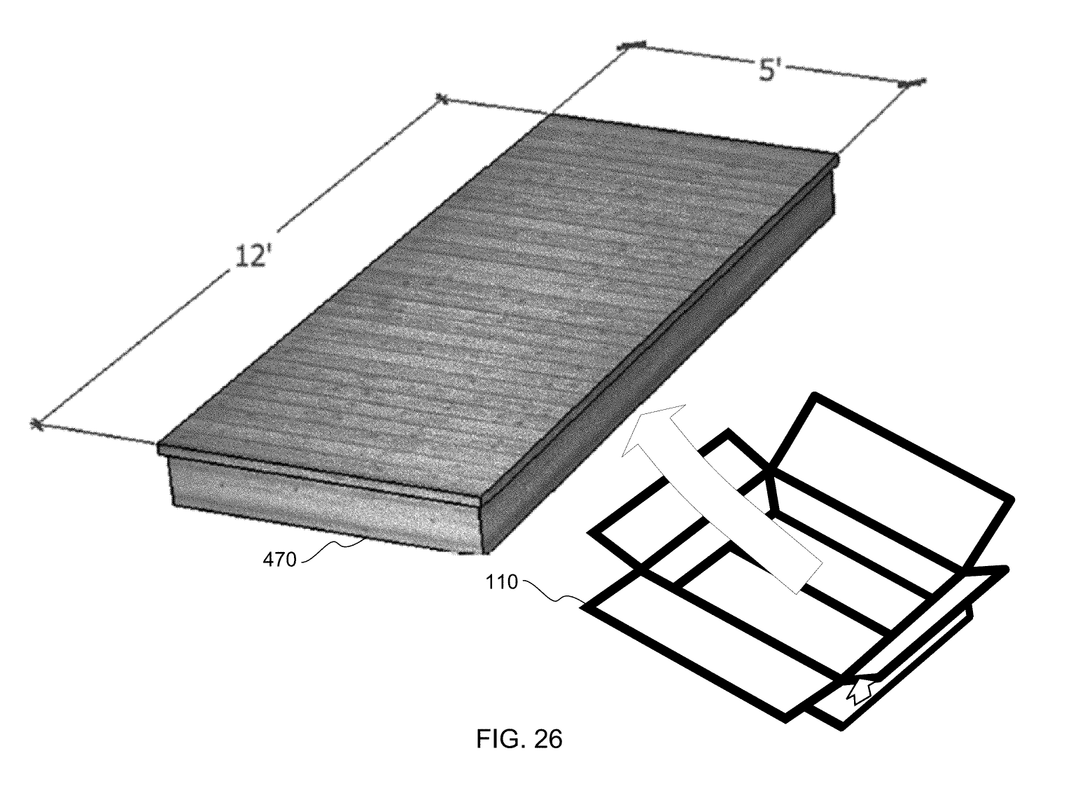

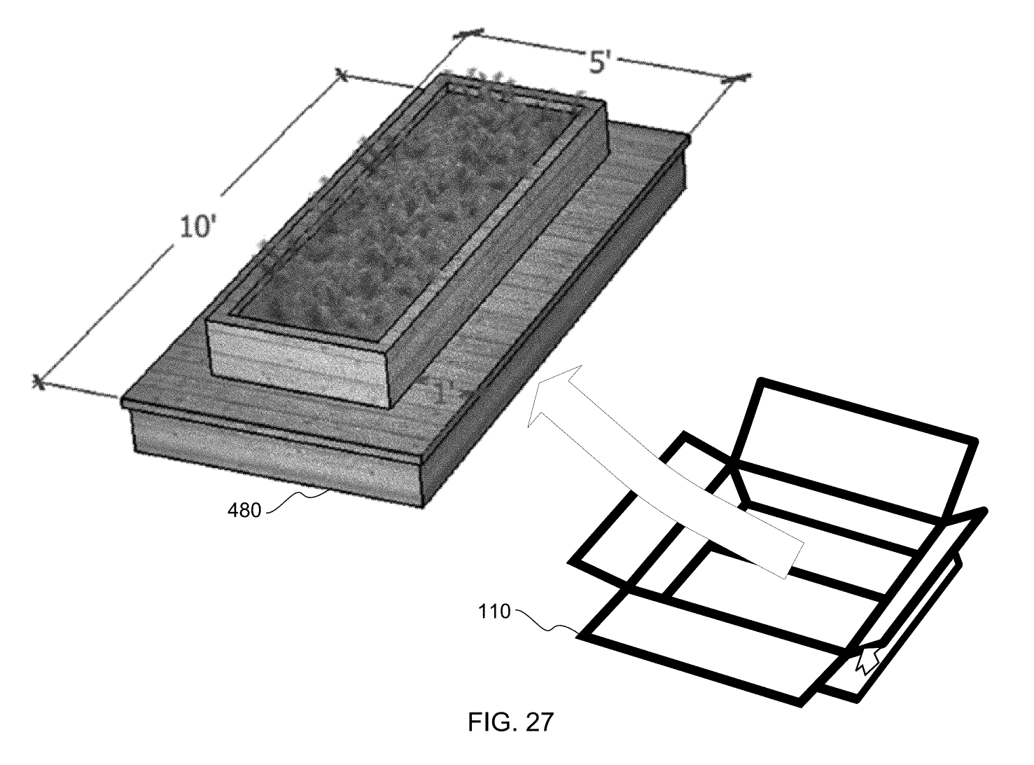

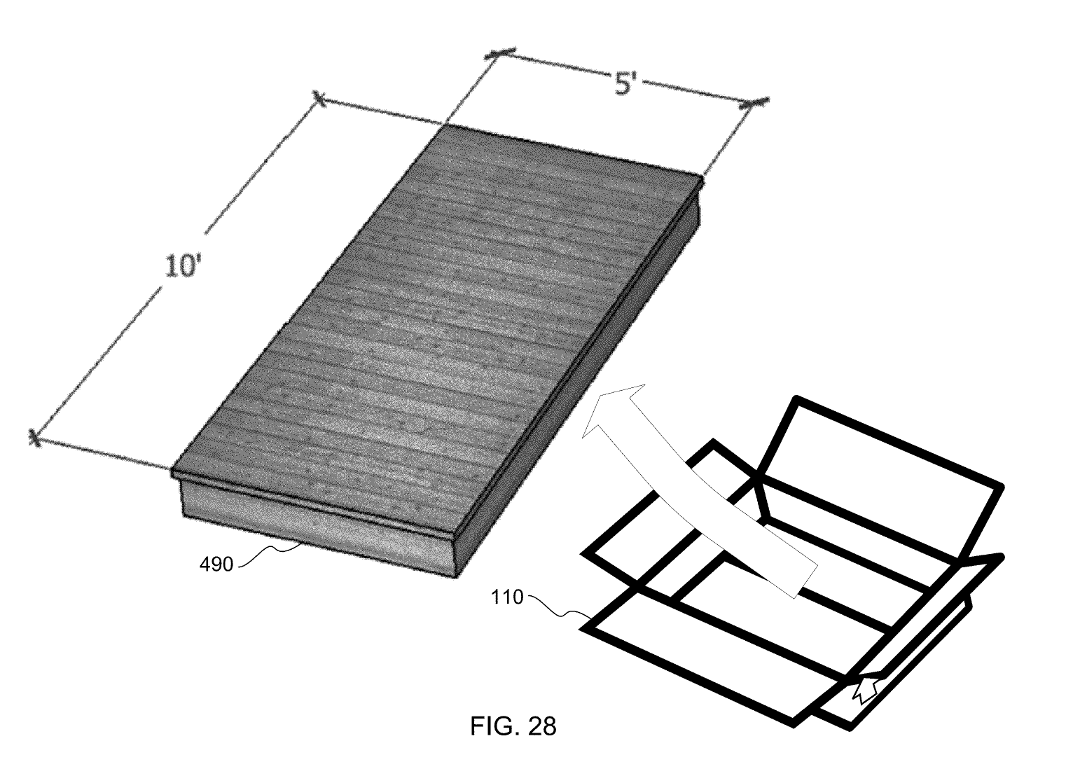

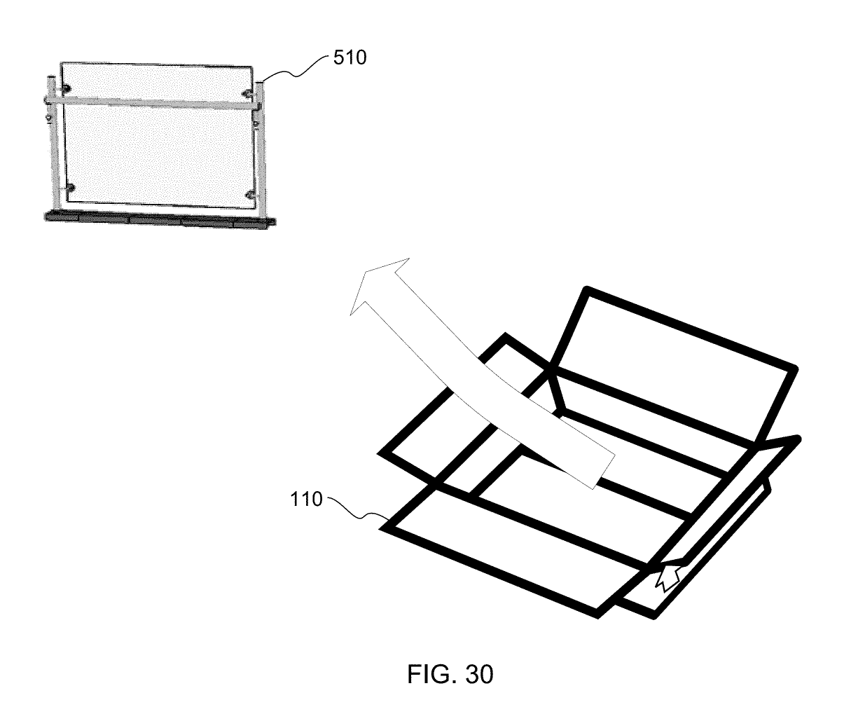

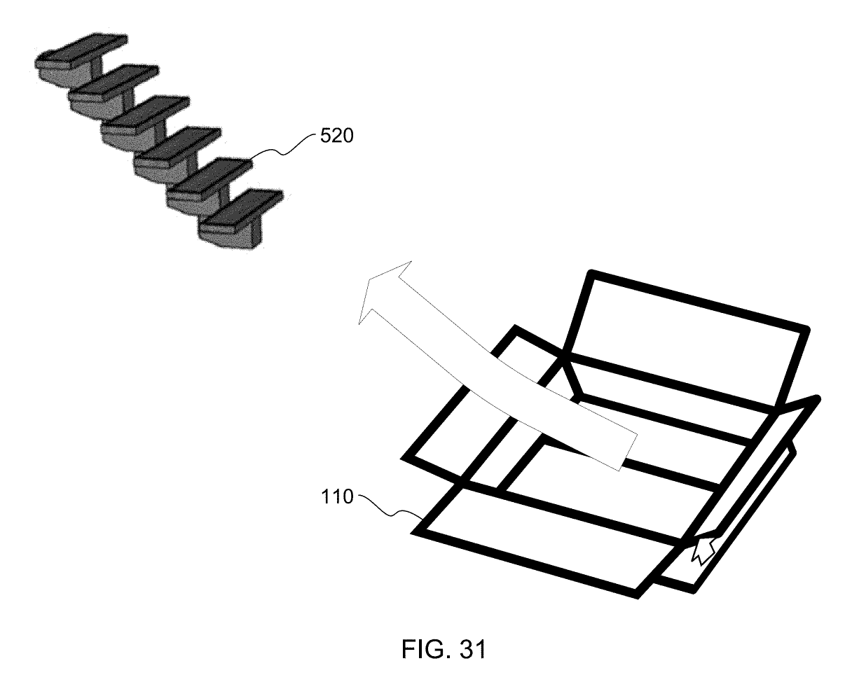

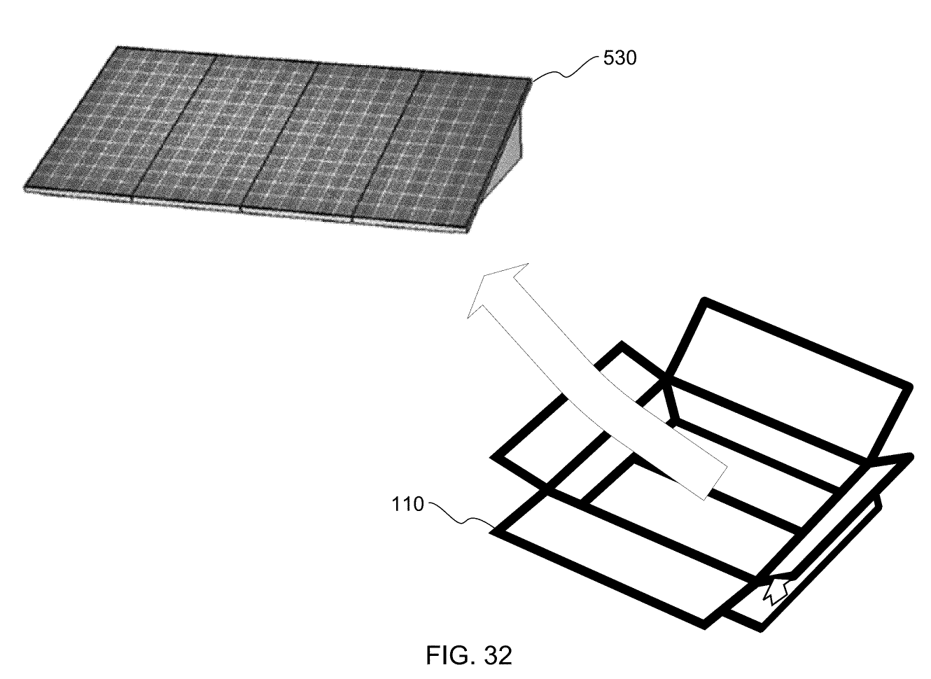

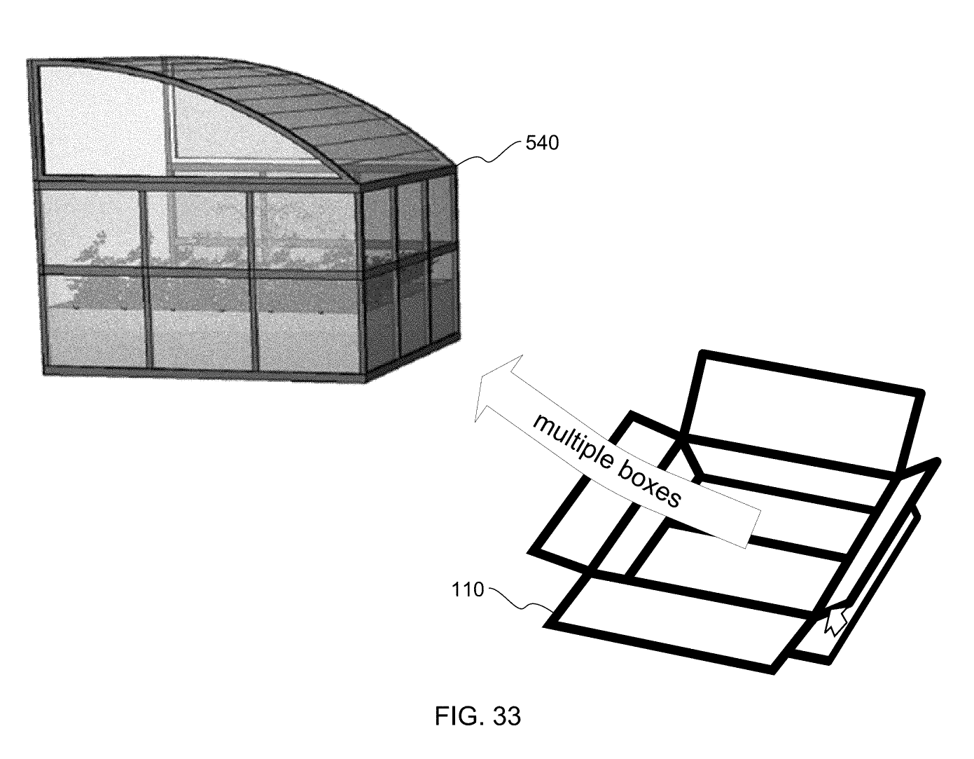

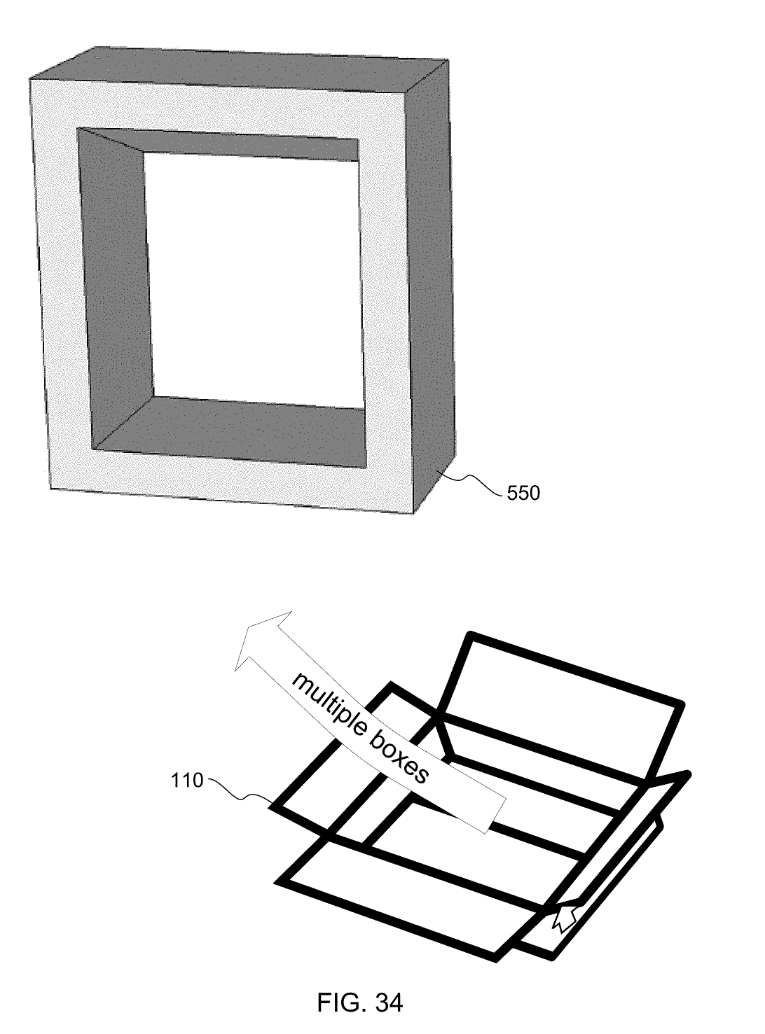

FIG. 4 illustrates a second exemplary set of mass-producible components and an example assembly of those components into a bespoke building. The example bespoke building assemblies 210, 220, 230, 240 could be part of a plan that the consumer is designing using the mass-producible components. Thus, this illustration is both an example of a catalog of mass-producible parts that could be printed, or provided as part of the on-line service offering described in relation to FIG. 2. Each of the mass-producible components 400, 410, 420, 430, 440, 450, 460, 570, 480, 490, 500, 510, 520, 530, 540, 550 illustrated in FIG. 4 is reproduced in greater detail in FIGS. 18-34.

FIGS. 5-17 illustrate in greater detail the exemplary mass-producible components of FIG. 3.

FIG. 5 illustrates a TYPE 1 OPENING WINDOW component 250. As illustrated, this example is a 4 foot by 4 foot window component 250 that can be opened. As illustrated, the component 250 advantageously can be boxed 110 for storage in a warehouse, for transport from the warehouse to a store, or for shipping or delivery to the consumer, or finally for recycling or disposal.

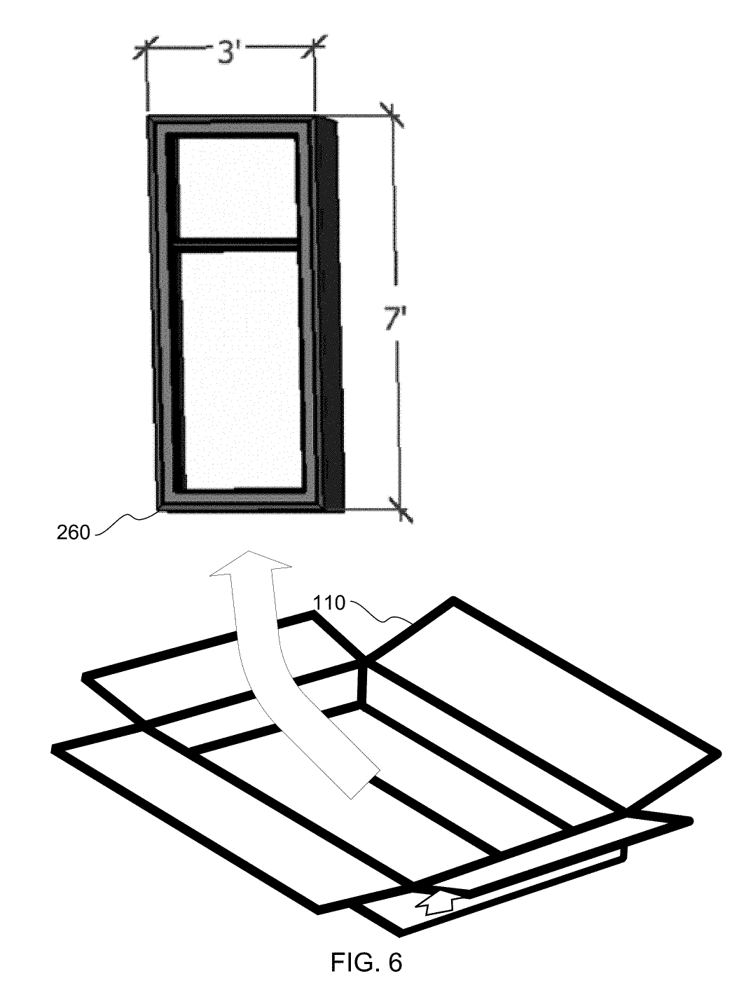

FIG. 6 illustrates a TYPE 2 FIXED WINDOW component 260. As illustrated, this example is a 3 foot by 7 foot window component 260 that is fixed, i.e. it cannot be opened, and is also illustrated with its box 110.

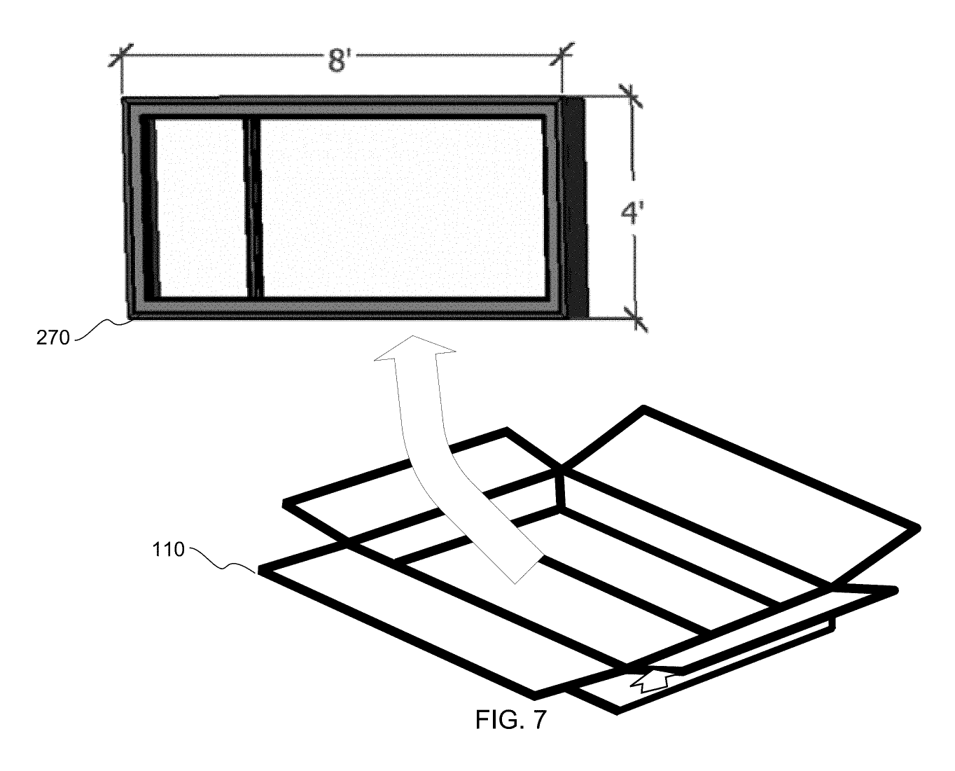

FIG. 7 illustrates a TYPE 3 OPENING WINDOW component 270. As illustrated, this example is a 8 foot by 4 foot window component 270 that can opened, and is shown with its box 110.

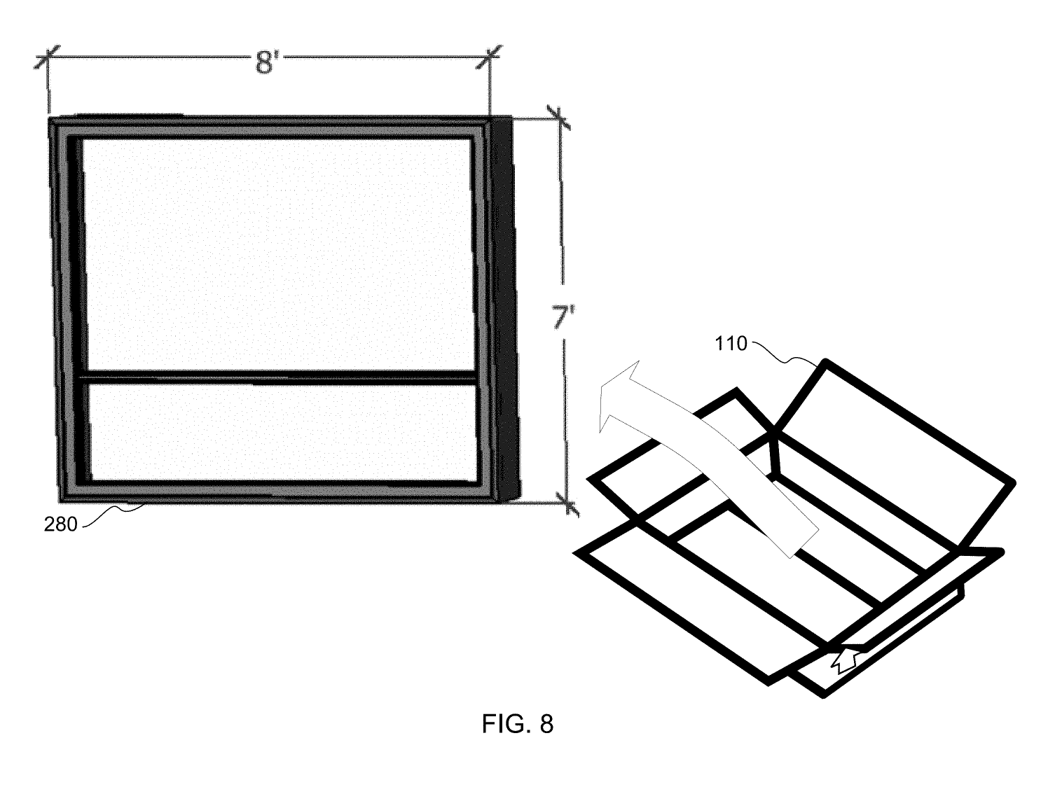

FIG. 8 illustrates a TYPE 4 OPENING WINDOW component 280. As illustrated, this example is a 8 foot by 7 foot window component 280 that can opened, and is shown with its box 110.

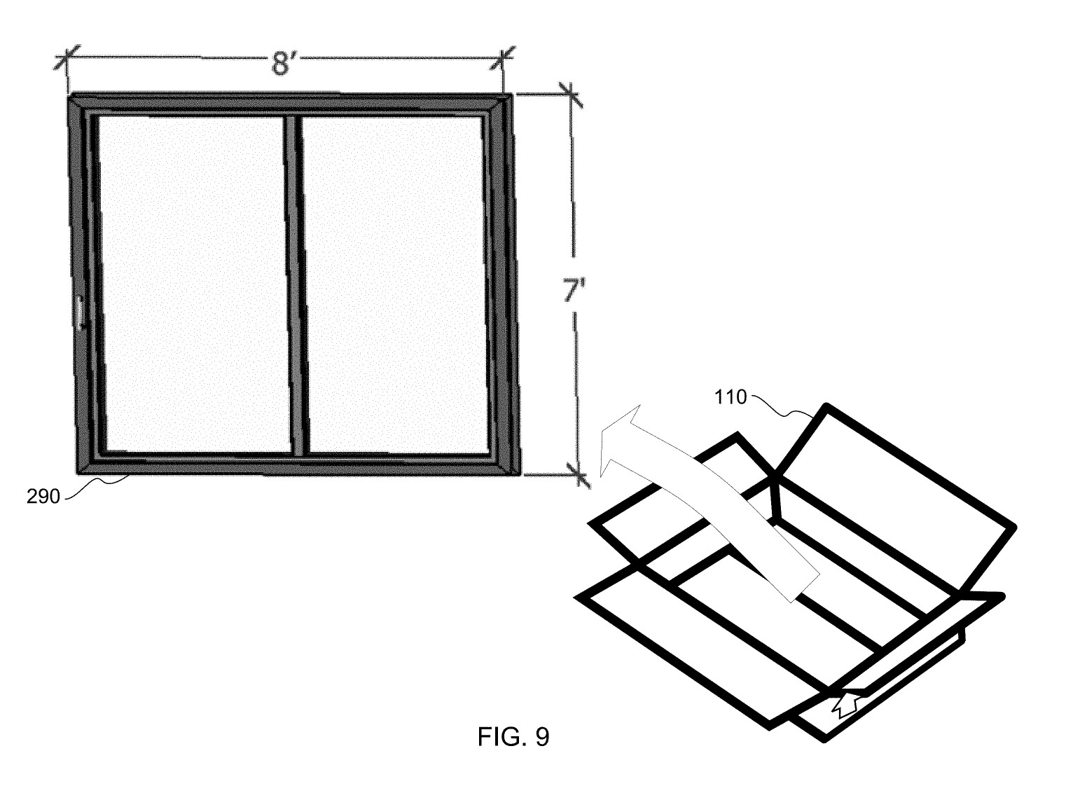

FIG. 9 illustrates a TYPE 1 PATIO DOOR component 290. As illustrated, this example is a 8 foot by 7 foot patio door component 290 that can be opened, and is shown with its box 110.

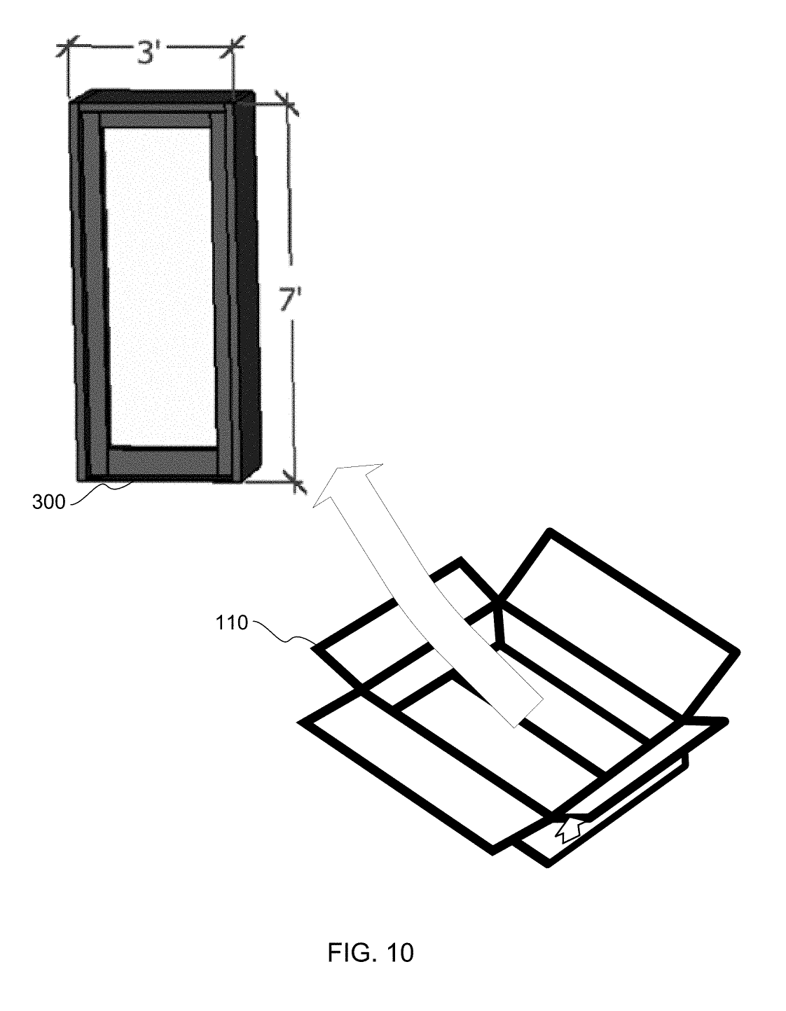

FIG. 10 illustrates a TYPE 1 GLASS DOOR component 300. As illustrated, this example is a 3 foot by 7 foot glass door component 300 that can opened, and is shown with its box 110.

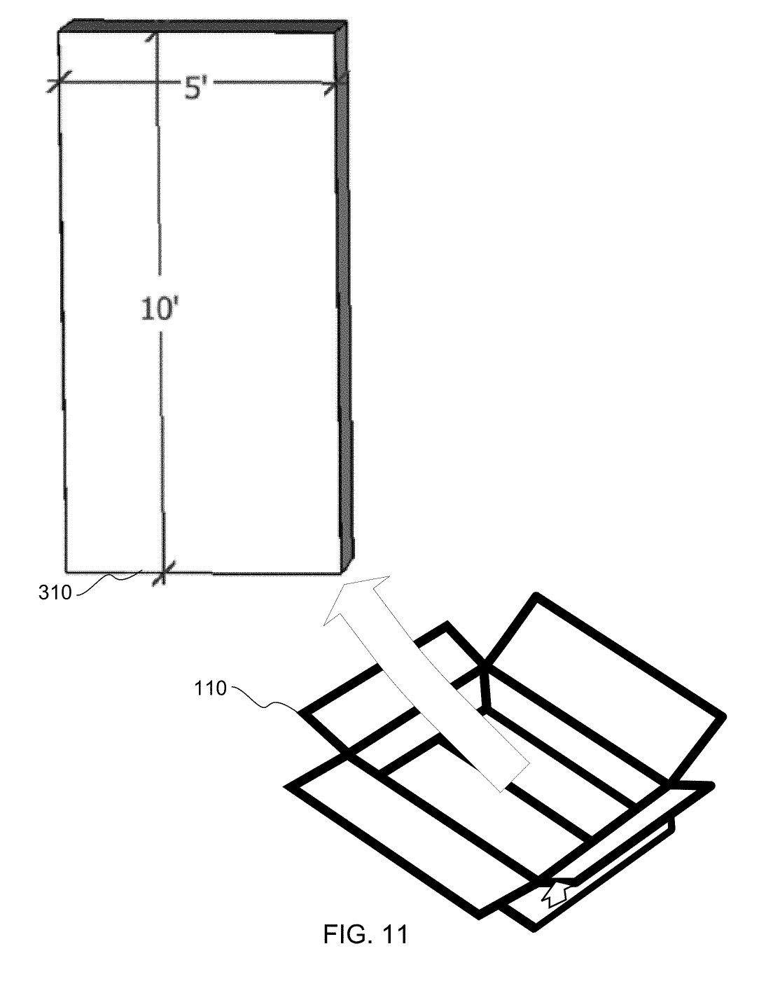

FIG. 11 illustrates an M1 SOLID INSULATED WALL component 310. As illustrated, this example is a 5 foot by 10 foot solid insulated wall component 310, shown with its box 110.

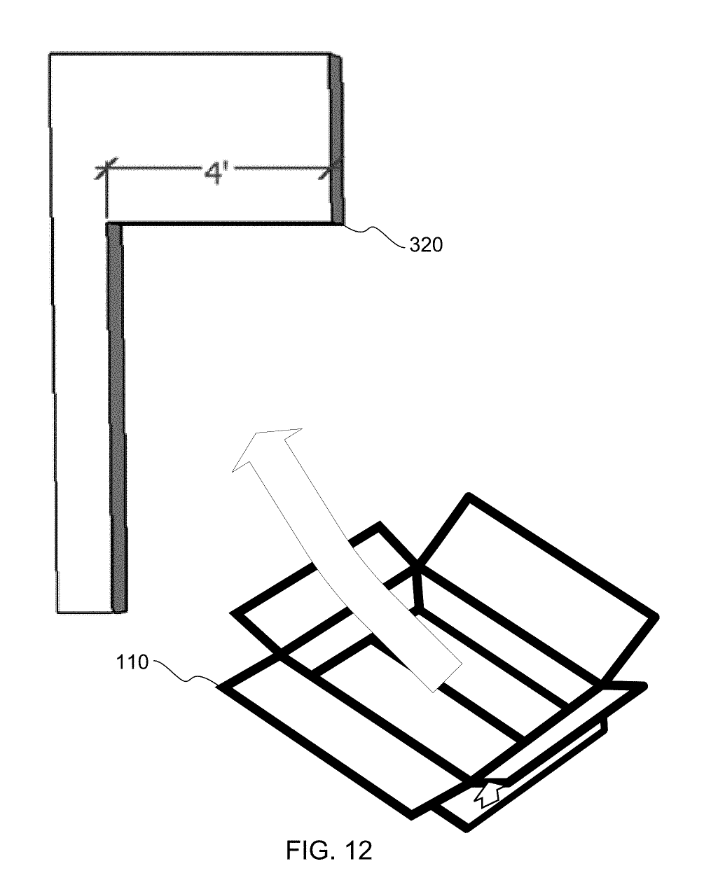

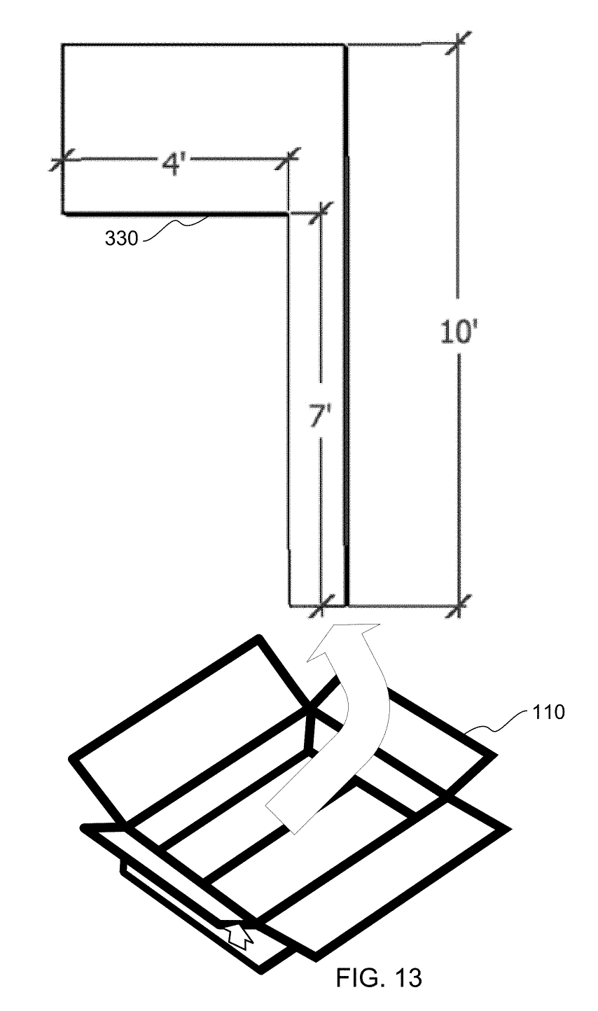

FIGS. 12 and 13 illustrate an M2.1 INSULATED WALL component 320 and an M2.2 INSULATED WALL component 330 respectively. As illustrated, these examples are substantially similar to the M1 wall component, except for the provision of a 4 foot by 7 foot recess on the lower right corner, and the lower left corner for M2.1 and M2.2 respectively, suitable for example to receive another component. Each of M2.1 and M2.2 are shown with their box.

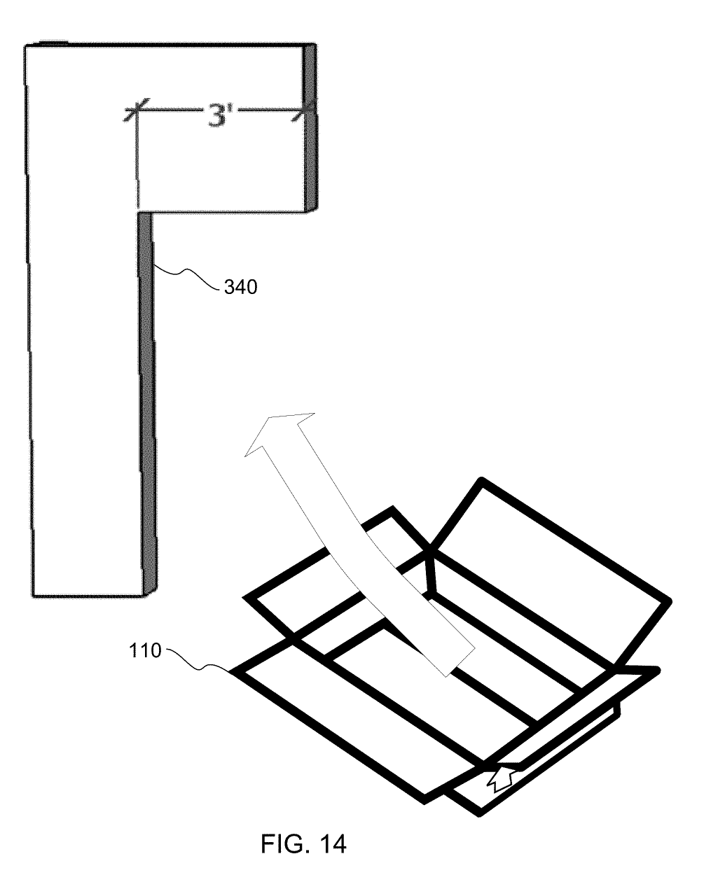

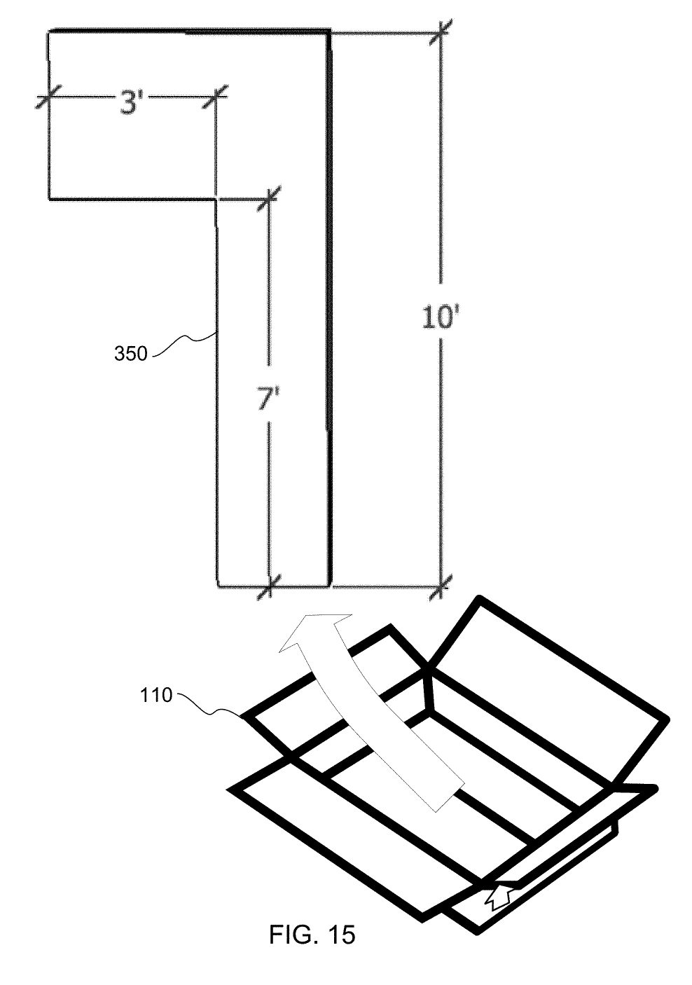

FIGS. 14 and 15 illustrate an M3.1 INSULATED WALL component and an M3.2 INSULATED WALL component respectively. As illustrated, these examples are substantially similar to the M1 wall component 310, except for the provision of a 3 foot by 7 foot recess on the lower right corner, and the lower left corner for M3.1 320 and M3.2 330 respectively, suitable for example to receive another component. Each of M3.1 320 and M3.2 320 are shown with their box 110.

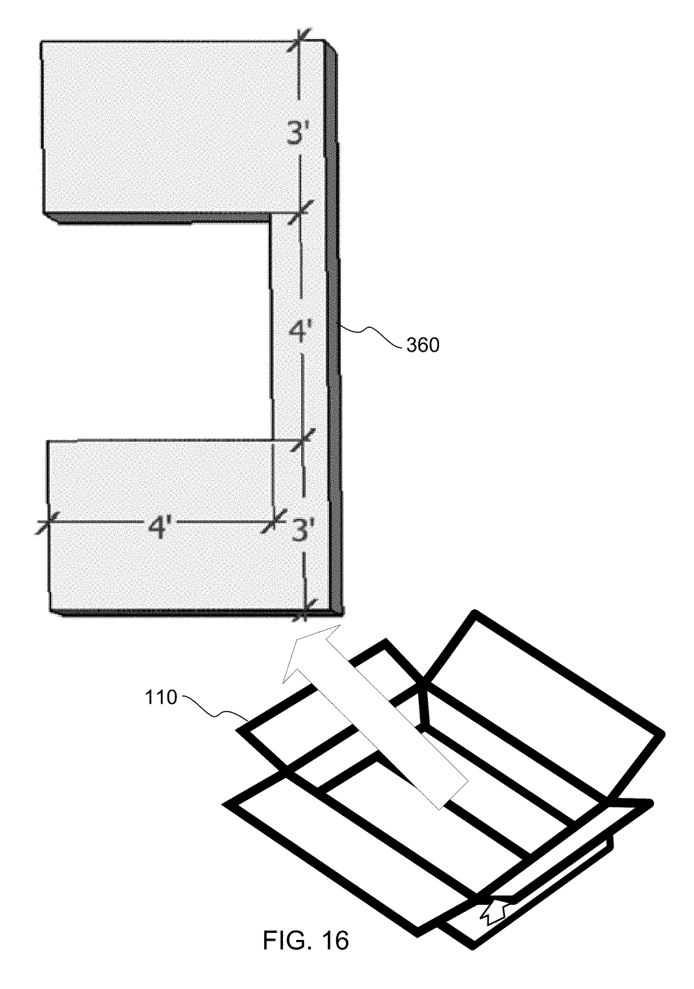

FIG. 16 illustrates an M.4 INSULATED WALL component 350. As illustrated, this example is substantially similar to the M1 wall component 310, except for the provision of a 4 foot by 4 foot recess centered on the left side, and is shown with its box 110.

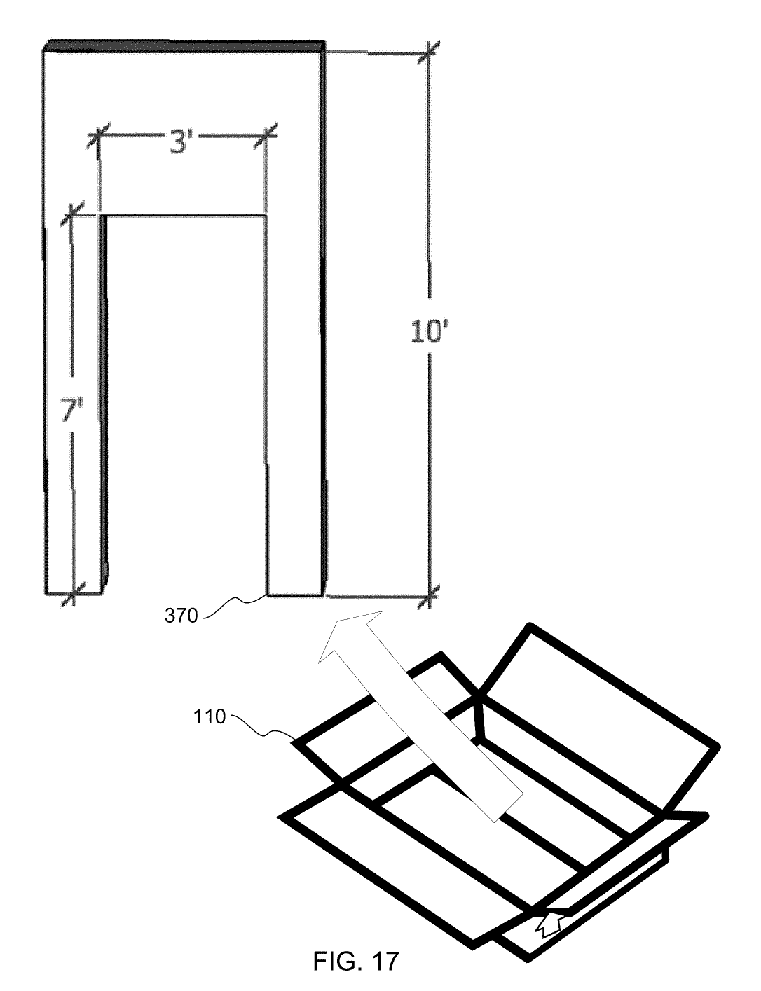

FIG. 17 illustrates an M.5 INSULATED WALL component 370. As illustrated, this example is substantially similar to the M1 wall component 310, except for the provision of a 3 foot by 7 foot recess centered on the bottom, and is shown with its box 110.

FIG. 18 illustrates a CORNER JUNCTION component 380A, a SIMPLE JUNCITON component 380B, and an EXTERIOR COLUMN component 380C. As illustrated, these examples are 1 foot by 10 foot, and are shown with their box 110.

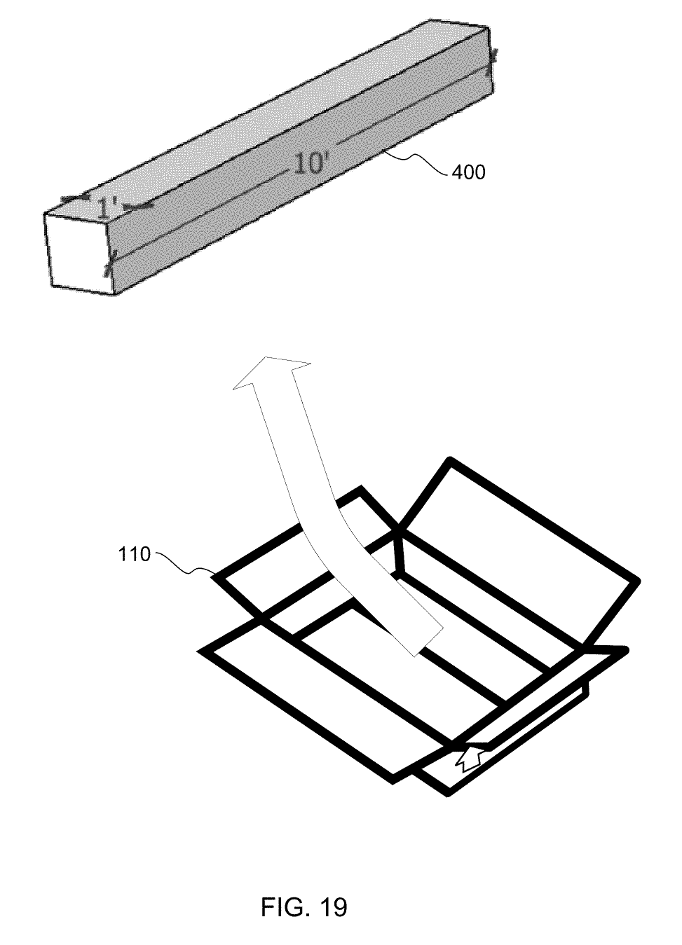

FIGS. 19-34 illustrate in greater detail the-exemplary mass-producible components of FIG. 4. It is envisaged that each of these mass-producible components can be manufactured with or without insulation.

FIG. 19 illustrates a BEAM 1 component 400. As illustrated, this example is a beam component 400 that is 1 foot by 10 foot, and is shown with its box 110.

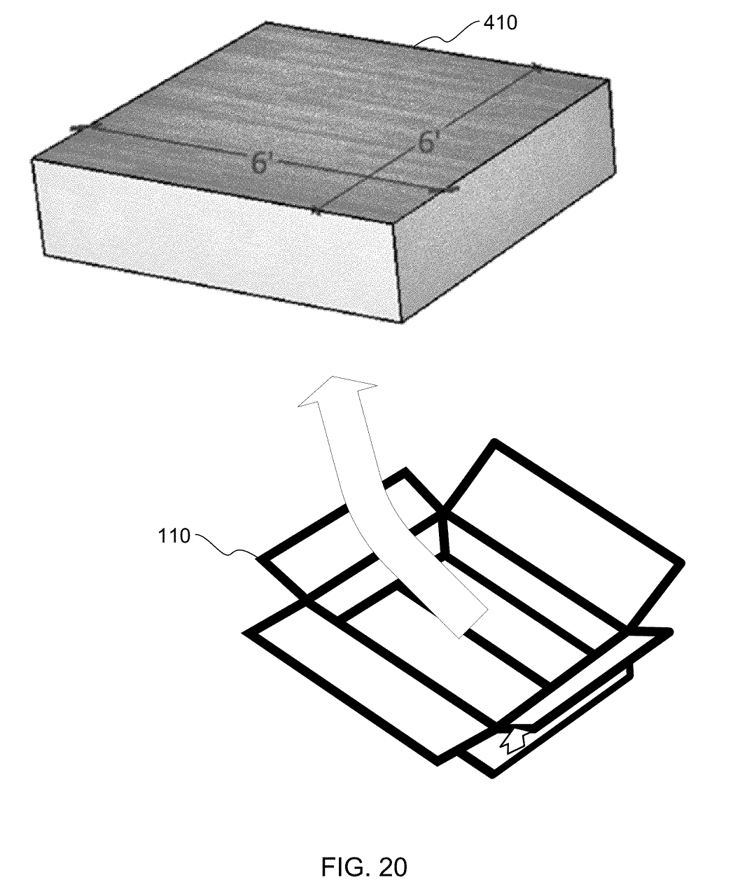

FIG. 20 illustrates a PL1/PL1S CEILING component 410. As illustrated, this example is a ceiling component that is 6 foot by 6 foot, and is shown with its box 110. When referenced as PL1, what is meant is the non-insulated component, and as PL1S, the insulated component—and more generally PLX and PLXS, where X is a number, are non-insulated and insulated versions of the same component. These components provide both floors as well as ceilings.

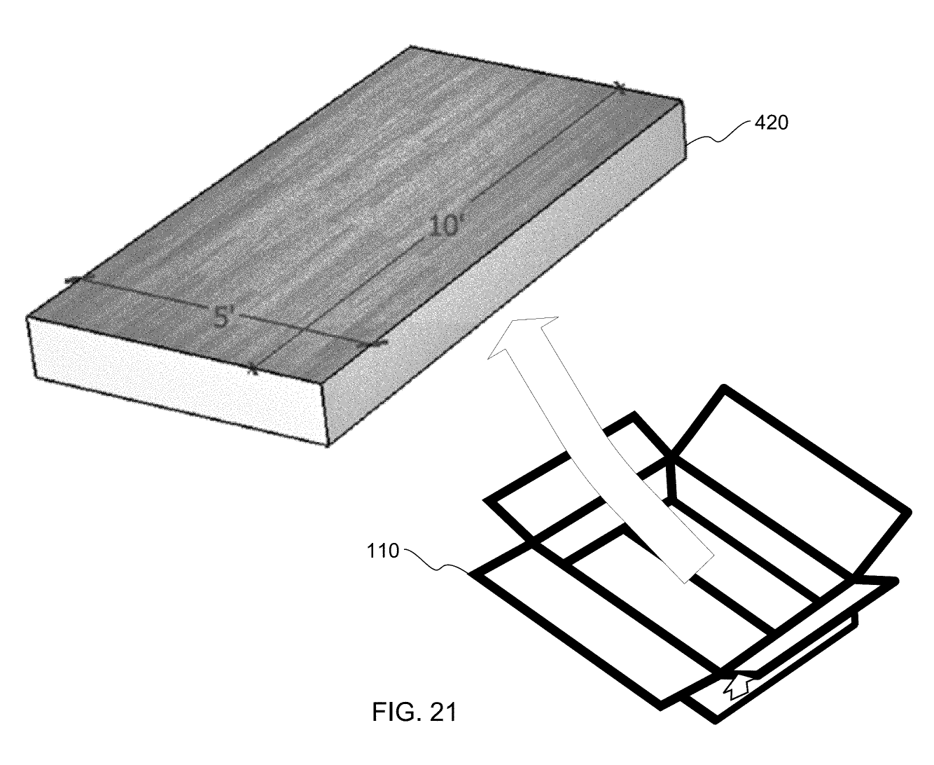

FIG. 21 illustrates a PL2/PL2S CELINING component 420. As illustrated, this example is a ceiling component 420 that is 5 foot by 10 foot, and is shown with its box 110.

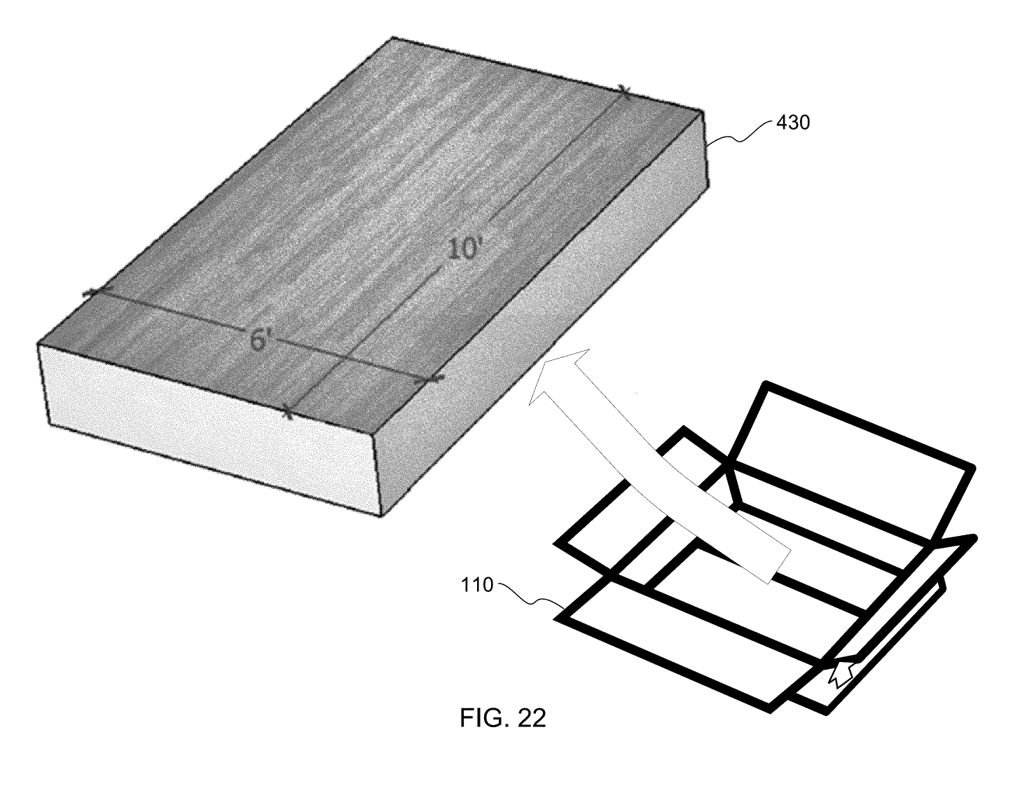

FIG. 22 illustrates a PL3/PL3S CELINING component 430. As illustrated, this example is a ceiling component 430 that is 6 foot by 10 foot, and is shown with its box 110.

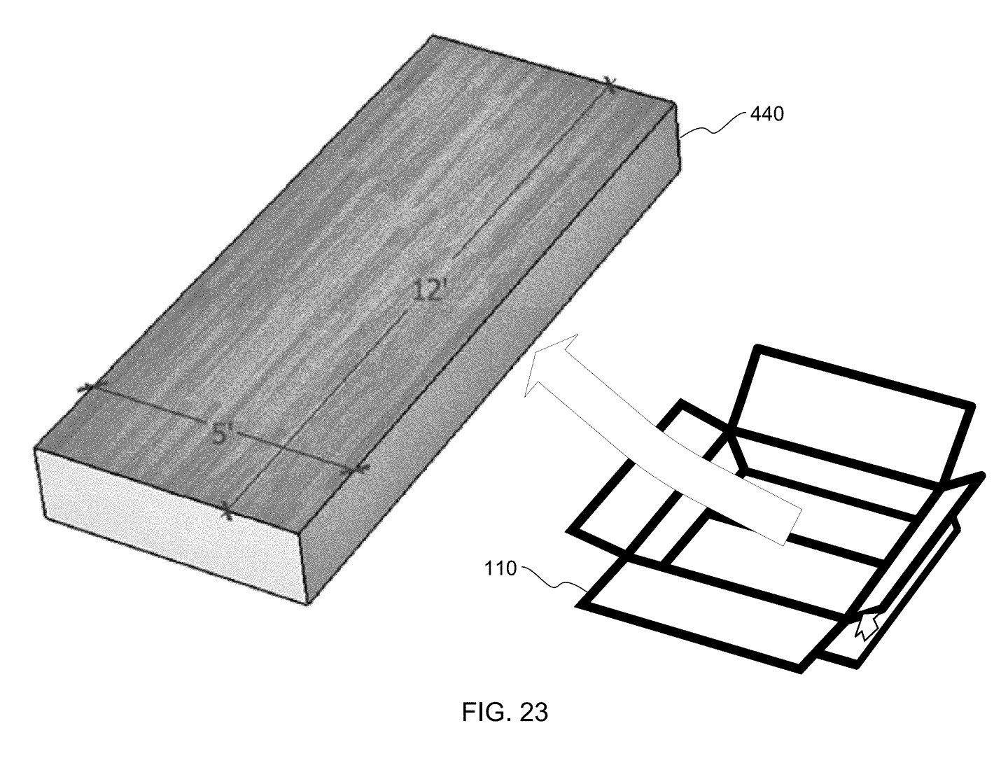

FIG. 23 illustrates a PL4/PL4S CELINING component 440. As illustrated, this example is a ceiling component 440 that is 5 foot by 12 foot, and is shown with its box 110.

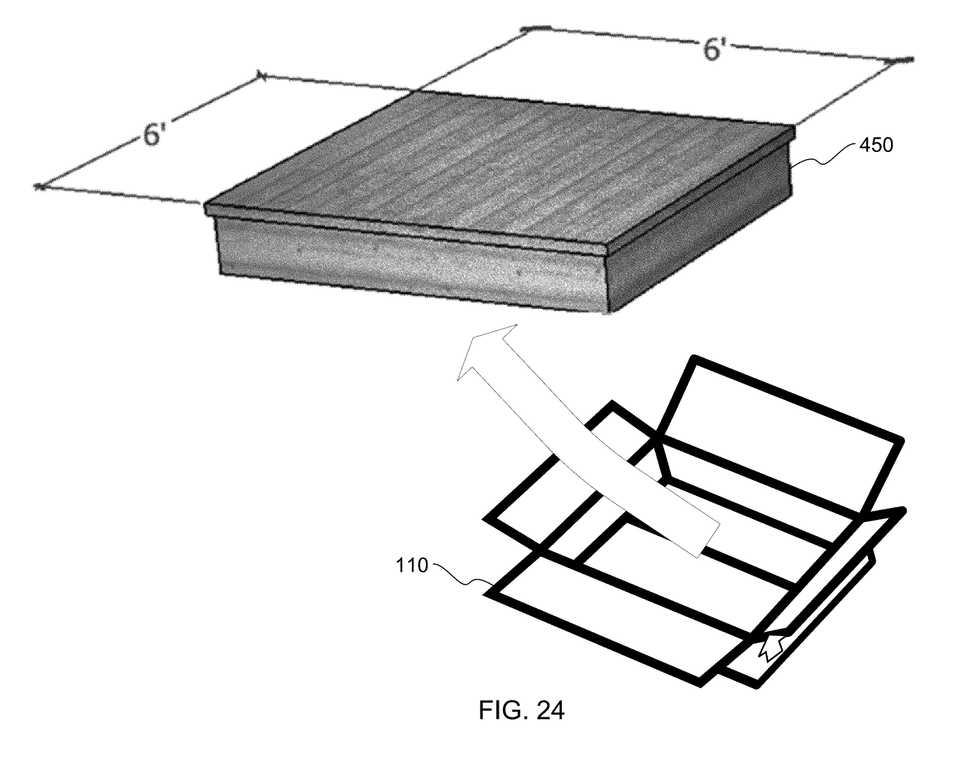

FIGS. 24-28 illustrate PT1 450, PT2 460, PT3 470, PT4 480, and PTT 490 PATIO components respectively. As illustrated, the example PT1/PT2/PT3/PTT examples are dimensioned the same as PL1/PL2/PL4/PL3 respectively. PT4 is sized as PT2 and provided with a planter box. PTT can be used as a roof-top terrace. Each component is shown with its box 110.

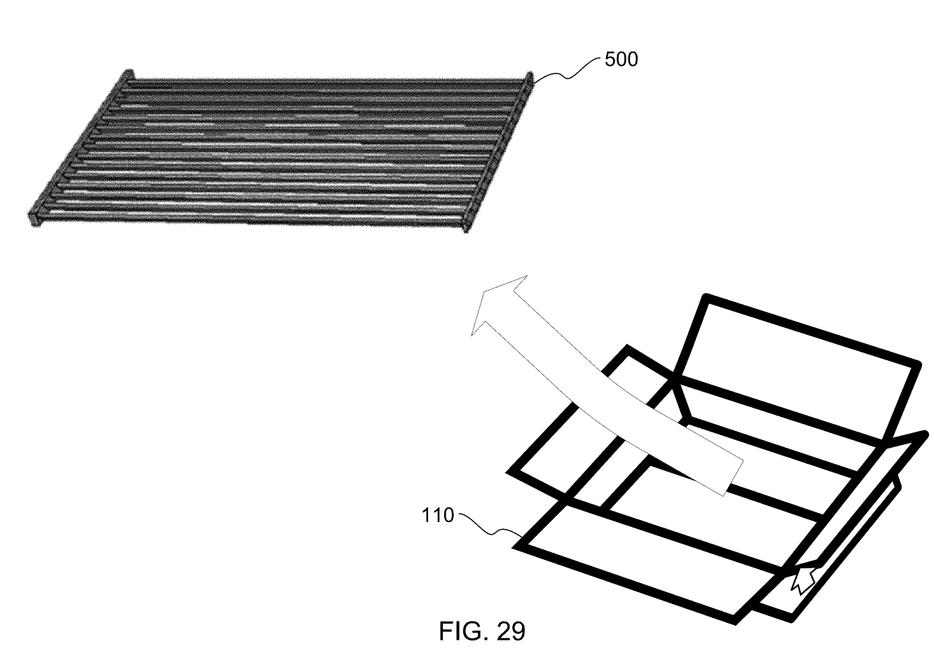

FIGS. 29-34 illustrate example mass-producible components that provide for particular exemplary bespoke components such as a modulable sun shade 500, a modulable guard rail 510, a modulable staircase 520, solar panels 530, a hydroponic greenhouse assembly 540, and a cantilevered terrace assembly 550 respectively, and are shown with their boxes 110.

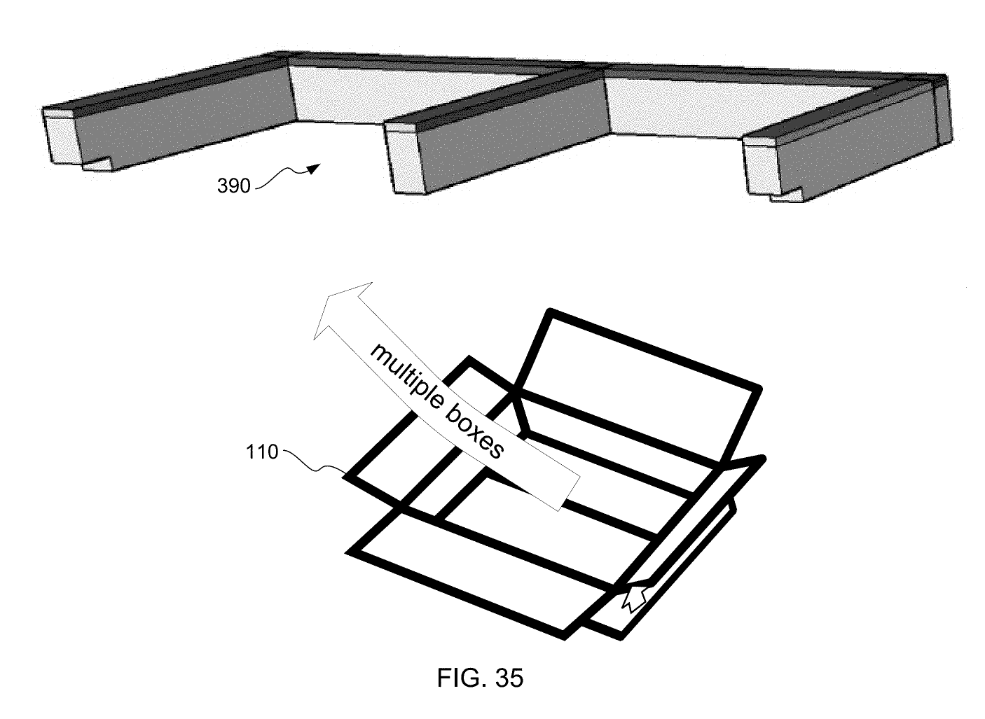

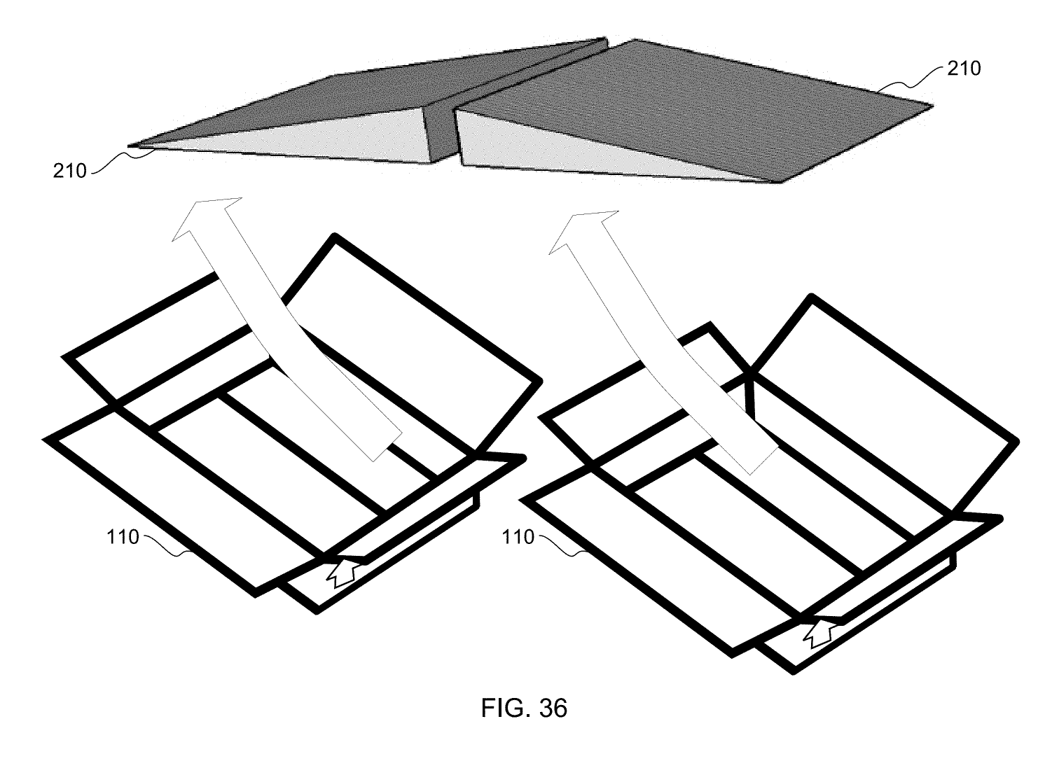

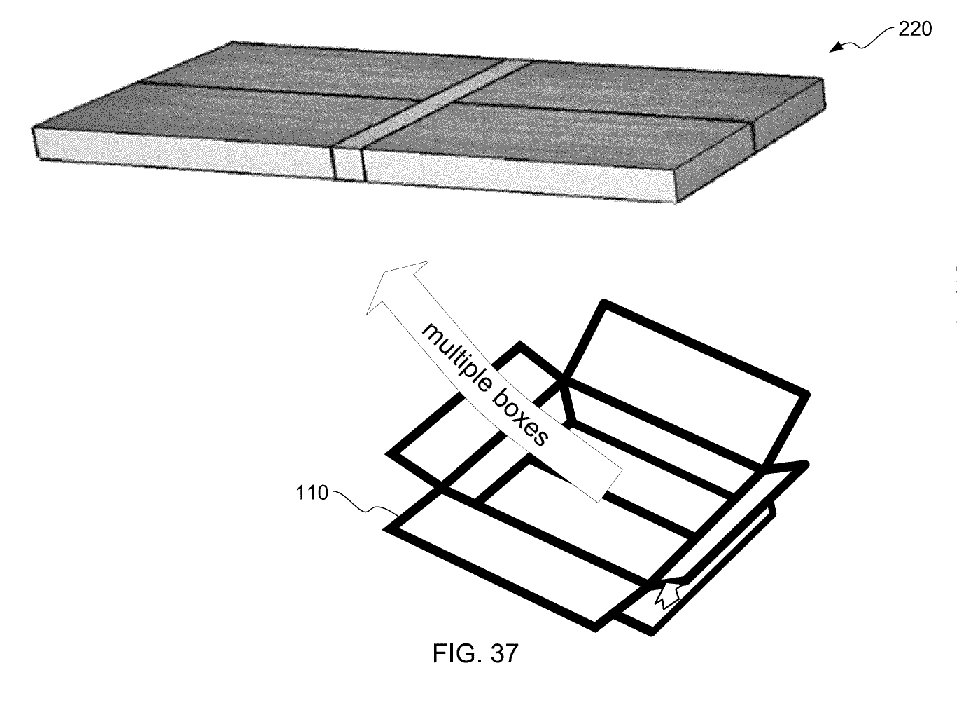

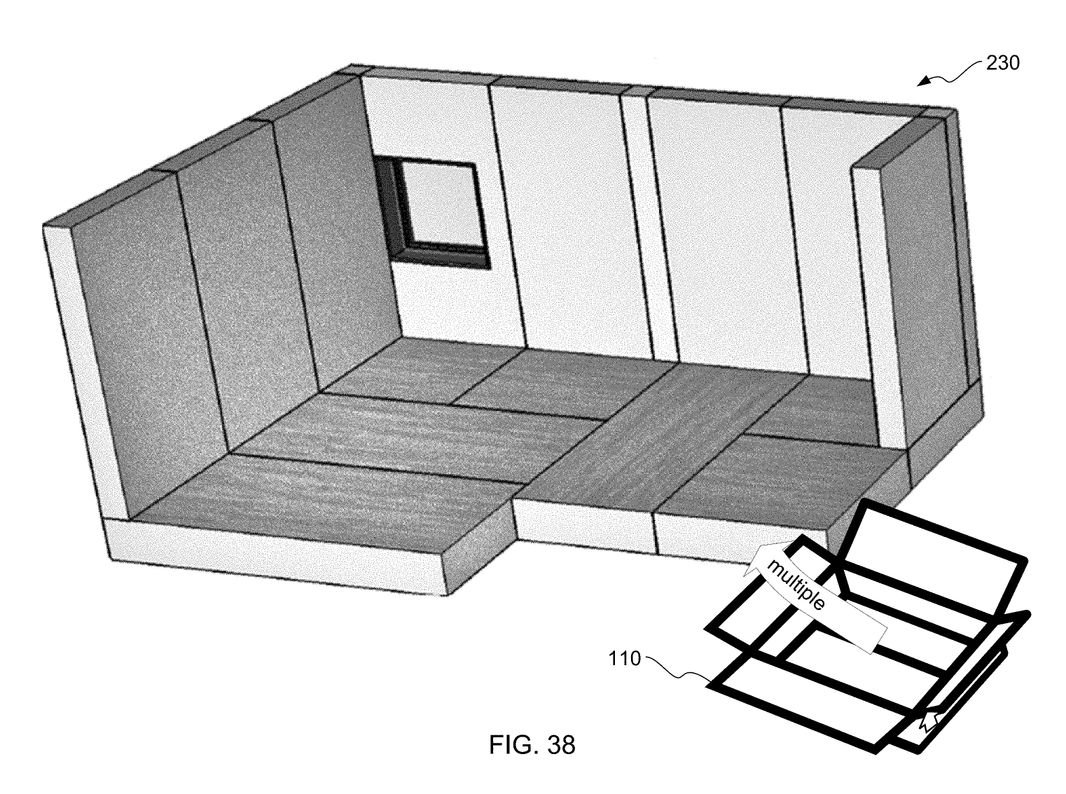

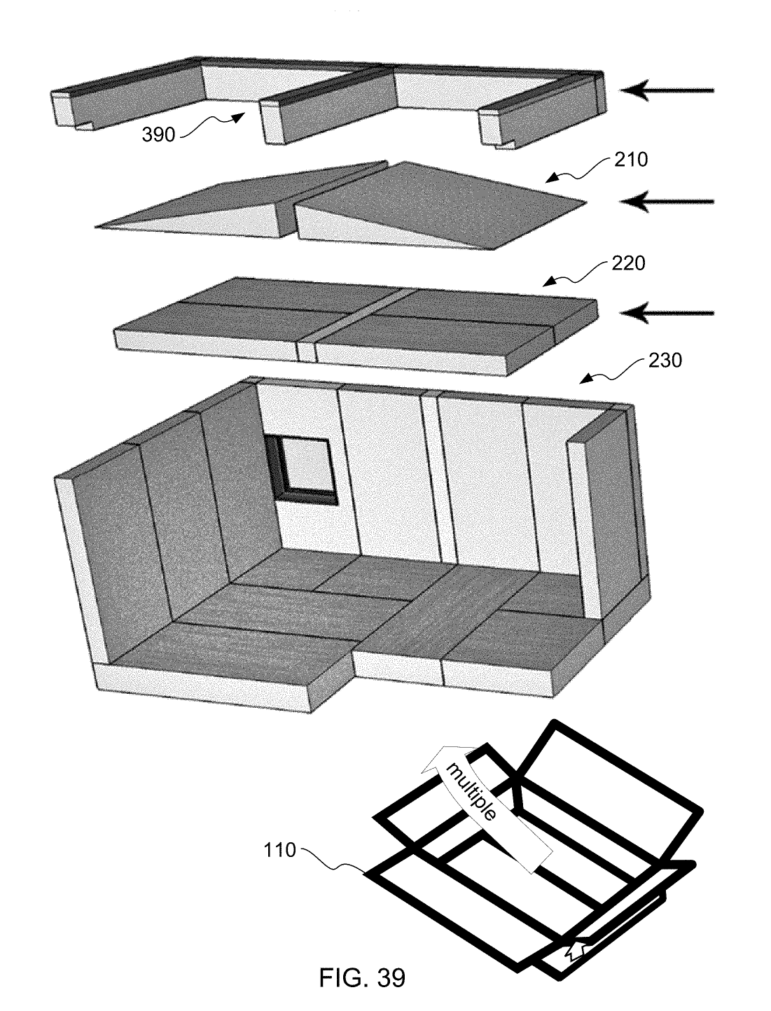

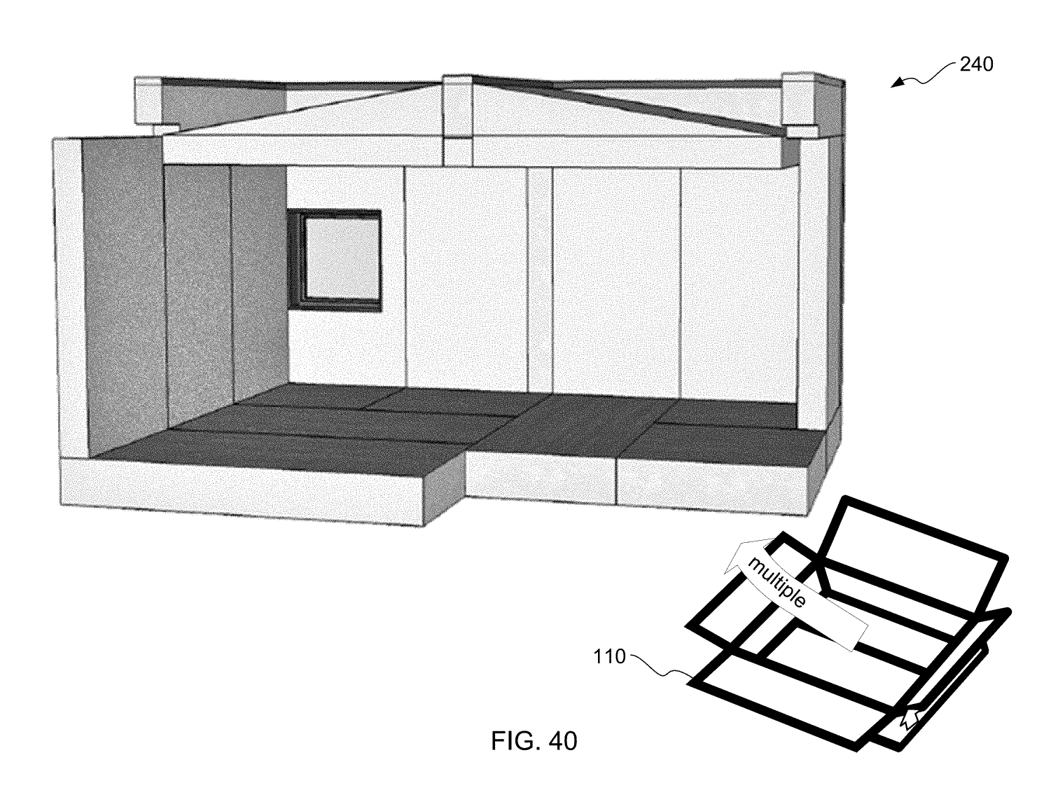

FIGS. 35-40 illustrate how several mass-producible components can be combined to make various bespoke assemblies and ultimately a bespoke building assembly, as well as the boxes for the mass-producible components used. FIG. 35 illustrates an exemplary PARAPET assembly 390, and the boxes 110 for the mass-producible components used. FIG. 36 illustrates an example ROOF assembly 210, featuring a suitable roof covering such as for example a metal covering, and the boxes 110 for the mass-producible components used. FIG. 37 illustrates a INSULATED CEILING assembly 220, and the boxes 110 for the mass-producible components used. FIG. 38 illustrates a FLOOR AND WALL assembly 230, and the boxes 110 for the mass-producible components used. FIG. 39 illustrates the assemblies of FIGS. 35-38 can be further assembled together, along with the required boxes. FIG. 40 illustrates a first example bespoke BUILDING ASSEMBLY 240 using the assemblies of FIGS. 35-39, as well as the boxes 110 for the mass-producible components utilized.

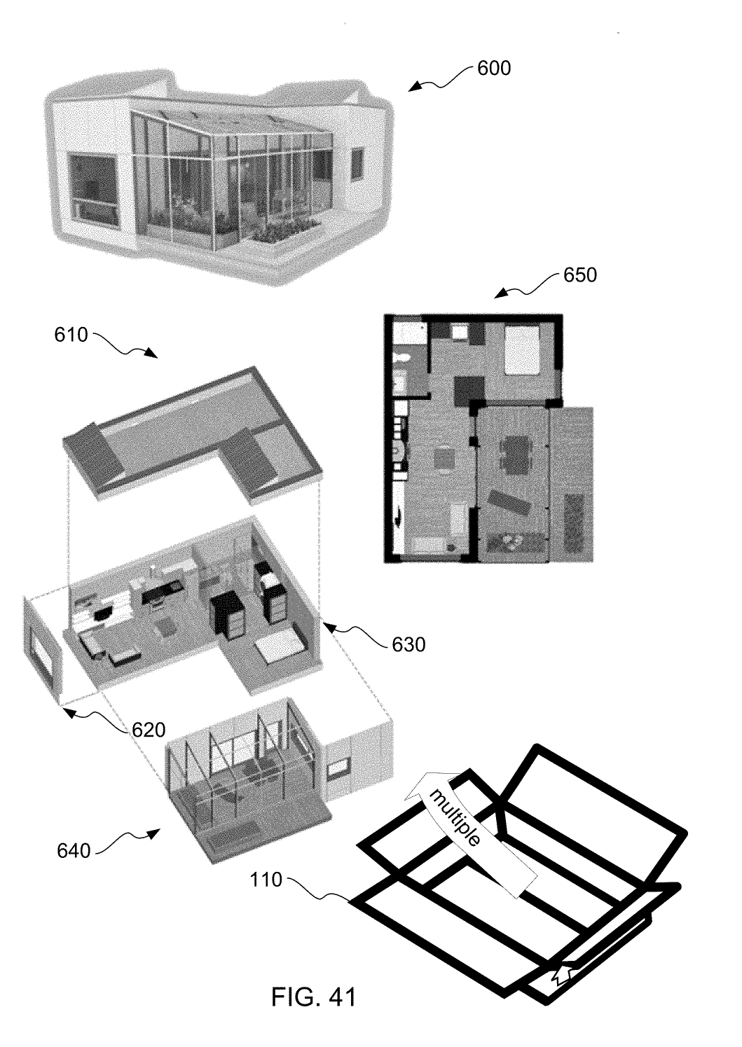

FIG. 41 illustrates a first exemplary mass-producible bespoke home built using mass-producible components. A perspective view 600, a first floor plan view 650, and an exploded view showing subassemblies 610, 620, 630, 640 are shown, along with the boxes 110 of the mass-producible components required for the building. Advantageously, a bespoke home having 1 bedroom, 1 bathroom and around 400 square feet is provided using the exemplary mass-producible parts disclosed herein.

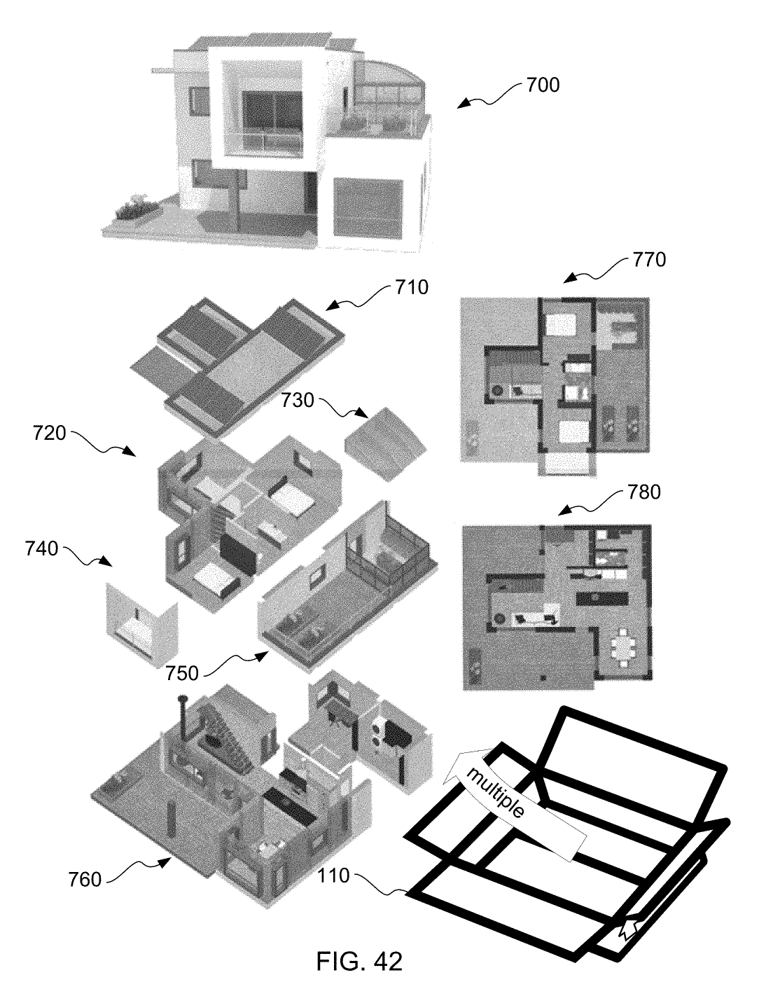

FIG. 42 illustrates a second exemplary mass-producible bespoke home built using mass-producible components. A perspective view 700, a first floor plan view 770, a second floor plan view 780, and an exploded view showing subassemblies 710, 720, 730, 740, 750, 760 are shown, along with the boxes of the mass-producible components required for the building. Advantageously, a two-storey bespoke home having a roof-top terrace and a patio, 2 bedrooms, 1 bathroom, a laundry room, and around 1000 square feet, is provided using the exemplary mass-producible parts disclosed herein.

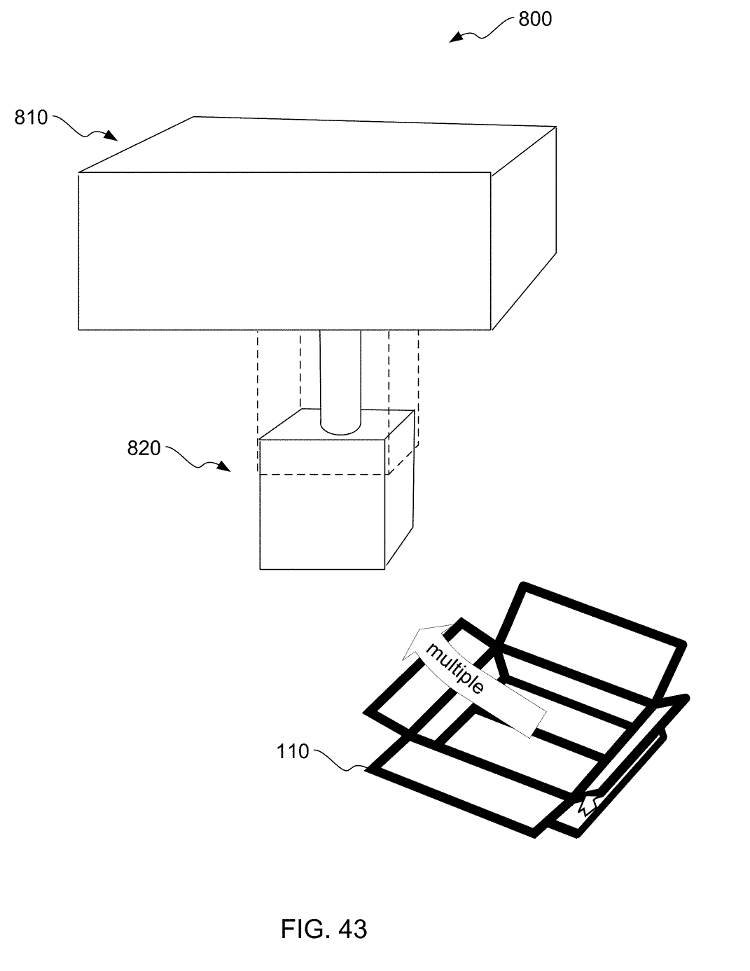

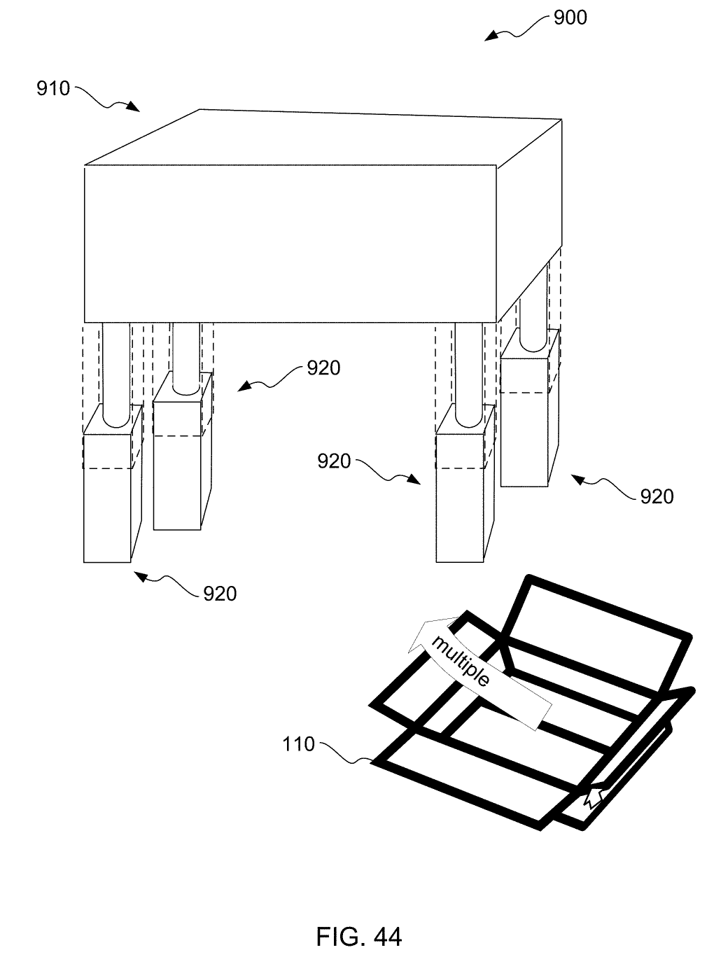

FIGS. 43 and 44 illustrate two example mass-producible flood proofing components 800, 900 that can be provided. Compressors 820, 920 are provided at pillars and support structures so as to enable the building 810, 910 to be advantageously lifted out of the way of flood waters and lowered once flood waters have receded. In FIG. 43, a central pillar and compressor 820 is illustrated cantered under the building 810, whereas in FIG. 44 four pillars and compressors 920 are illustrated at each corner of the building 910.

The above-described embodiments of the present techniques are intended to be examples only. Those of skill in the art may effect alterations, modifications and variations to the particular embodiments without departing from the scope of the techniques of this disclosure

What is claimed is:

1. A method of mass-producing components of bespoke buildings, the method comprising the steps of:
(a) manufacturing mass-producible components;
(b) boxing the mass-producible components;
(c) stocking boxes of the mass-producible components;
(d) selecting at least one box of the mass-producible components;
(e) providing the selected at least one box of the mass-producible components;
(f) unboxing the provided at least one box of the mass-producible components;
(g) building at least a portion of a bespoke building using the provided unboxed at least one mass-producible components.

2. The method of claim 1, wherein the mass-producible components of step (a) include at least one of a window component, a door component, a wall component, a junction component, a column component, a beam component, a floor component, a ceiling component, a roof component, a staircase component, a solar panel component, a patio component, and a compressor component.

3. The method of claim 2, wherein the window component is one of a 4 foot by 4 foot window component, a 3 foot by 7 foot window component, and a 8 foot by 7 foot window component.

4. The method of claim 2, wherein the window component is one of a fixed window component and an opening window component.

5. The method of claim 2, wherein the door component is one of an 8 foot by 7 foot door component, and a 3 foot by 7 foot door component.

6. The method of claim 2, wherein the door component is one of a patio door component and a glass door component.

7. The method of claim 2, wherein the wall component is a 5 foot by 10 foot wall component.

8. The method of claim 2, wherein a component is insulated.

9. The method of claim 2, wherein the wall component includes a recess.

10. The method of claim 2, wherein the recess in the wall component is one of a 4 foot by 7 foot recess on a lower corner of the wall component, a 3 foot by 7 foot recess on a lower corner of the wall component, a 4 foot by 4 foot recess centred on a side of the wall component, and a 3 foot by 7 foot recess on a bottom of the wall component.

11. The method of claim 2, wherein the junction component is one of a corner junction component and a simple junction component.

12. The method of claim 2, wherein the column component is an exterior column component.

13. The method of claim 2, wherein one of the junction component, the column component, and the beam component is 1 foot by 10 foot.

14. The method of claim 2, wherein one of the ceiling component and the floor component is one of 6 foot by 6 foot, 5 foot by 100 foot, 6 foot by 10 foot, and 5 foot by 12 foot.

15. The method of claim 2, wherein the ceiling component and the floor component are provided by the same component.

16. The method of claim 2, wherein the patio component is one of a modulable sun shade, a modulable guard rail, a modulable staircase, a solar panel.

17. The method of claim 2, wherein the portion of the bespoke building includes a bespoke assembly.

18. The method of claim 2, wherein the bespoke assembly is one of a greenhouse assembly, a cantilevered terrace assembly, a parapet assembly, a roof assembly, a ceiling assembly, a floor assembly, a wall assembly, a floor and wall assembly.

19. The method of claim 2, further comprising the step of building at least two bespoke assemblies using the unboxed provided mass-producible components; and combining the at least two bespoke assemblies to provide a bespoke building.

20. A mass-producible bespoke building comprising:
(a) a mass-producible bespoke floor assembly including a plurality of mass-producible floor components;
(b) a mass-producible bespoke wall assembly including a plurality of components including at least one mass-producible wall component, at least one mass-producible window component, and at least one mass-producible door component;
(c) a mass-producible bespoke ceiling assembly including a plurality of mass-producible ceiling components; and
(d) a mass-producible bespoke roof assembly including a plurality of mass-producible roof components;
wherein each of the components is produced by the method of claim 1.

21. The mass producible bespoke building of claim 1, further comprising a mass-producible bespoke patio assembly including a plurality of mass-producible patio components.
